(19) United States
(12) Patent Application Publication
(10) Pub. No.: US 2026/0339464 A1
(43) Pub. Date: Oct. 29, 2026

(54) CIRCUITRY FOR TOUCH-SENSITIVE APPARATUS AND METHOD

(71) Applicant: TouchNetix Limited, Fareham, Hampshire (GB)

(72) Inventor: Stephen William ROBERTS, Fareham, Hampshire (GB)

(73) Assignee: TouchNetix Limited, Fareham, Hampshire (GB)

(21) Appl. No.: 19/486,255

(22) PCT Filed: May 14, 2024
(86) PCT No.: PCT/GB2024/051251

§ 371 Date: Nov. 20, 2025

(30) Foreign Application Priority Data
May 26, 2023 (GB) 2307911.4

(51) Int. Cl. G06F 3/041; G06F 3/044

(52) U.S. Cl. CPC G06F 3/04182; G06F 3/0446; G06F 2203/04111

(57) ABSTRACT

Described is circuitry for a touch-sensitive apparatus including a first signal generating module configured to generate a first signal representing a sinusoidal wave having a first frequency; a second signal generating module configured to generate a second signal representing a sinusoidal wave having a second frequency, the second frequency being different to the first frequency; and processing circuitry configured to perform processing on one or more received signals. The circuitry is configured to: apply the first signal to one or more electrodes of an electrode array for a first time period, apply the second signal to one or more electrodes for a second time period, and determine whether a touch or object has been detected at a sensing surface corresponding to the electrode array based on the result of applying the first signal to the first received signal and/or applying the second signal to the second received signal.

### BACKGROUND OF THE INVENTION

The present invention relates to the field of touch sensors, for example touch sensors for overlying a display screen to provide a touch-sensitive display (touch screen). In particular, embodiments of the invention relate to techniques for measuring the capacitance using drive electrodes and receive electrodes for sensing the presence of one or more touching objects within a two-dimensional sensing area.

A capacitive touch sensor can be generalised as one that uses a physical sensor element comprising an arrangement of electrically conductive electrodes extending over a touch sensitive area (sensing area) to define sensor nodes (or intersection points) and controller circuitry connected to the electrodes and operable to measure changes in the electrical capacitance of each of the electrodes or the mutual-capacitance between combinations of the electrodes. The electrodes are typically provided on a substrate.

For such capacitive touch sensors, circuitry is arranged to apply an analogue signal (i.e. a time-varying voltage) to the electrodes in order to perform a measurement of the capacitance. Such a signal typically results in an analogue signal (such as a time varying current) that is received or obtained from the electrodes, with this analogue signal including information regarding the measured capacitance for a given electrode or at a given intersection point. Techniques have been developed for analysing the analogue signal and for determining whether a touch (or an object) is present.

However, in some respects, these techniques are not optimal and offer certain disadvantages in certain applications. In particular, external noise can couple to the electrode array and subsequently impair the reliability of the capacitive touch sensor to determine whether a touch is present or not. There is therefore a desire to provide circuitry for touch sensors which can offer an improvement processing of received signals from the electrode array.

### SUMMARY OF THE INVENTION

According to a first aspect of the disclosure there is provided circuitry for a touch-sensitive apparatus including a first signal generating module configured to generate a first signal representing a sinusoidal wave having a first frequency; a second signal generating module configured to generate a second signal representing a sinusoidal wave having a second frequency, the second frequency being different to the first frequency; and processing circuitry configured to perform processing on one or more received signals. The circuitry is configured to: apply the first signal to one or more electrodes of an electrode array for a first time period and obtain a first received signal from the electrode array while the first signal is applied to the electrode array for the first time period, apply the second signal to one or more electrodes of an electrode array for a second time period and obtain a second received signal from the electrode array while the second signal is applied to the electrode array for the second time period, and determine whether a touch or object has been detected at a sensing surface corresponding to the electrode array based on the result of applying the first signal to the first received signal and/or applying the second signal to the second received signal. Determining whether a touch or object has been detected at the sensing surface is further based on an indication of the noise associated with the first received signal and/or second received signal, wherein an indication of the noise associated with the first received signal is obtained by applying the first signal to the second received signal and wherein an indication of the noise associated with the second received signal is obtained by applying the second signal to the first received signal.

According to a second aspect of the disclosure there is provided touch-sensitive apparatus including the circuitry according to the first aspect; and an electrode array coupled to the circuitry.

According to a third aspect of the disclosure there is provided a method for determining the presence of a touch or object at a touch-sensitive apparatus. The method includes providing a first signal representing a sinusoidal wave having a first frequency; providing a second signal representing a sinusoidal wave having a second frequency, the second frequency being different to the first frequency; applying the first signal to one or more electrodes of an electrode array for a first time period and obtain a first received signal from the electrode array while the first signal is applied to the electrode array for the first time period; applying the second signal to one or more electrodes of an electrode array for a second time period and obtain a second received signal from the electrode array while the second signal is applied to the electrode array for the second time period; and determining whether a touch or object has been detected at a sensing surface corresponding to the electrode array based on the result of applying the first signal to the first received signal and/or applying the second signal to the second received signal. Determining whether a touch or object has been detected at the sensing surface is further based on an indication of the noise associated with the first received signal and/or second received signal, wherein an indication of the noise associated with the first received signal is obtained by applying the first signal to the second received signal and wherein an indication of the noise associated with the second received signal is obtained by applying the second signal to the first received signal.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

The invention is now described by way of example only with reference to the following drawings in which:

FIG. 1 schematically illustrates a touch sensitive apparatus incorporating measurement circuitry in accordance with certain embodiments of the invention;

FIG. 2 schematically illustrates a self-capacitance measurement mode of the touch sensitive apparatus of FIG. 1, specifically with a view to explaining the principles of self-capacitance measurement;

FIG. 3 schematically illustrates a mutual-capacitance measurement mode of the touch sensitive apparatus of FIG. 1, specifically with a view to explaining the principles of mutual capacitance measurement;

FIG. 4 schematically illustrates the circuitry of the touch sensitive apparatus of FIG. 1 in more detail in accordance with certain embodiments of the invention, and in particular, circuitry that is configured to apply one of two drive signals to a sensor element where the drive signals are of different frequencies;

FIGS. 5a to 5d are a series of schematic drawings showing a technique for obtaining measurements for multiple electrodes of the sensor element; and

FIG. 6 shows a flow chart depicting a method for determining the presence or absence of a touch received from an electrode array taking account of an indication of noise.

### DETAILED DESCRIPTION

The present disclosure relates broadly to circuitry for use in a touch-sensitive apparatus configured to determine whether a touch or object has been detected at a sensing surface (sometimes referred to as a touch-sensitive surface). The circuitry is configured to generate one or more drive signals for applying to an electrode array, and to receive one or more received signals from the electrode array indicative of a capacitive coupling between an object, such as a user's finger or a held stylus. The circuitry is capable of determining whether a touch or object has been detected based on an analysis of the received signals. In addition, the circuitry is capable of determining an indication of the noise associated with received signals and is capable of taking the indication of the noise into consideration when determining whether a touch or object has been sensed by the touch-sensitive apparatus.

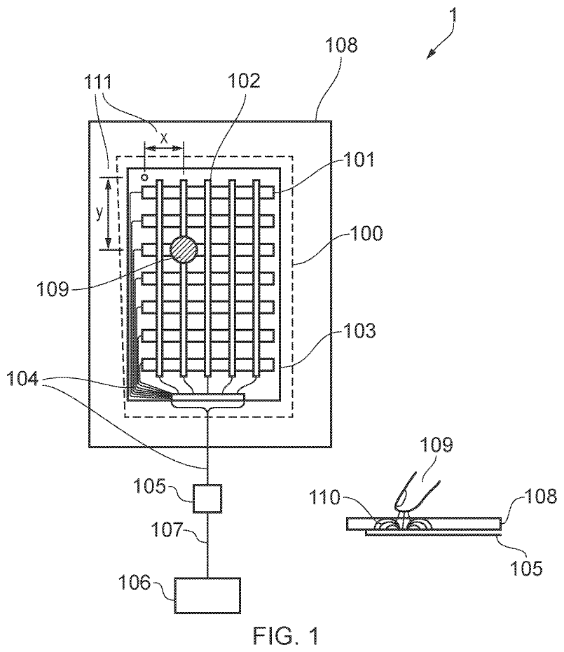

FIG. 1 schematically shows an example touch-sensitive apparatus 1. The touch-sensitive apparatus 1 is represented in plan view (to the left in the figure) and also in cross-sectional view (to the right in the figure).

The touch-sensitive apparatus 1 comprises a sensor element 100, measurement circuitry 105, control circuitry 106, and cover 108. The sensor element 100 and cover 108 may, more generally be referred to as a touch-sensitive element of the touch-sensitive apparatus 1, while the measurement circuitry 105 and control circuitry 106 may, collectively, be referred to as the controller of the touch-sensitive apparatus 1.

The touch screen is primarily configured for establishing the position of a touch (or multiple touches) within a two-dimensional sensing area by providing Cartesian coordinates along an X-direction (horizontal in the figure) and a Y-direction (vertical in the figure). In this implementation, the sensor element 100 is constructed from a substrate 103 that could be glass or plastic or some other insulating material and upon or within which is arranged an array of electrodes (referred to herein as an electrode array) consisting of multiple laterally extending parallel electrodes, X-electrodes 101 (row electrodes), and multiple vertically extending parallel electrodes, Y-electrodes 102 (column electrodes), which in combination allow the position of a touch 109 to be determined. To clarify the terminology, and as will be seen from FIG. 1, the X-electrodes 101 (row electrodes) are aligned parallel to the X-direction and the Y-electrodes 102 (column electrodes) are aligned parallel to the Y-direction. Thus the different X-electrodes allow the position of a touch to be determined at different positions along the Y-direction while the different Y-electrodes allow the position of a touch to be determined at different positions along the X-direction. That is to say in accordance with the terminology used herein, the electrodes are named (in terms of X- and Y-) after their direction of extent rather than the direction along which they resolve position. Furthermore, the electrodes may also be referred to as row electrodes and column electrodes. It will however be appreciated these terms are simply used as a convenient way of distinguishing the groups of electrodes extending in the different directions. In particular, the terms are not intended to indicate any specific electrode orientation. In general the term “row” will be used to refer to electrodes extending in a horizontal direction for the orientations represented in the figures while the terms “column” will be used to refer to electrodes extending in a vertical direction in the orientations represented in the figures. The X-electrodes 101 and Y-electrodes 102 define a sensing (or sense) area, which is a region of the substrate 103 which is sensitive to touch. In some cases, each electrode 101, 102 may have a more detailed structure than the simple “bar” structures represented in FIG. 1, but the operating principles are broadly the same.

The electrodes of the electrode array are made of an electrically conductive material such as copper or Indium Tin Oxide (ITO). The nature of the various materials used depends on the desired characteristics of the touch sensitive apparatus 1. For example, a touch screen (e.g., a touch-sensitive apparatus 1 comprising a display screen) may need to be transparent, in which case ITO electrodes and a plastic substrate are formed accordingly. On the other hand a touch pad, such as often provided as an alternative to a mouse in laptop computers is usually opaque, and hence can use lower cost copper electrodes and an epoxy-glass-fibre substrate (e.g. FR4).

Referring back to FIG. 1, the electrodes 101, 102 are electrically connected via circuit conductors 104 to measurement circuitry 105, which is in turn connected to control circuitry 106 by means of a circuit conductor 107. The measurement circuitry 105 and/or the control circuitry 106 may each be provided by a (micro)controller, processor, ASIC or similar form of control chip. Although shown separately in FIG. 1, in some implementations, the measurement circuitry 105 and the control circuitry 106 may be provided by the same (micro)controller, processor, ASIC or similar form of control chip. The measurement circuitry 105 and/or the control circuitry 106 may be comprised of a printed circuit board (PCB), which may further include the various circuit conductors 104, 107. The measurement circuitry 105 and the control circuitry 106 may be formed on the same PCB, or separate PCBs. Note also that the functionality provided by either of the measurement circuitry 105 and the control circuitry 106 may be split across multiple circuit boards and/or across components which are not mounted to a PCB.

Generally speaking, the measurement circuitry 105 is configured to perform capacitance measurements associated with the electrodes 101, 102. The measurement circuitry 105 includes elements capable of generating and applying electrical signals (drive signals) for performing capacitance measurements. As described in more detail below, the measurement circuitry 105 outputs at least indications of the capacitance measurements to the control circuitry 106.

The control circuitry 106 may be configured to perform a number of functions, including controlling the operations of the measurement circuitry 105. For example, the control circuitry 106 may send control signals to the various components forming the measurement circuity 105 for controlling the operation of these components. In the described implementation, the control circuitry 106 is also provided with the capability to determine the presence of a touch 109, caused by an object such a human finger or a stylus coming into contact with (or being adjacent to) the sense area of the sensor element 100, based on an appropriate processing of signals obtained from the electrode array by the measurement circuitry 105. Depending on the implementation at hand, the control circuitry 106, may also be configured to calculate a position of the touch 109 on the cover's surface as an XY coordinate 111 (based on an identification of corresponding electrodes of the electrode array that capacitive couple to the touch 109). Accordingly, the control circuitry 106 may therefore also be referred to as processing circuitry.

As described above, the functions of the control circuitry 106 may be provided across different circuit boards/components, and in the context of the implementation described above, it should be appreciated that dedicated circuit boards/components for the control of the measurement circuitry 105 and for processing of the capacitance measurements may be provided.

In the example of FIG. 1, a front cover (also referred to as a lens or panel) 108 is positioned in front of the substrate 103 and a single touch 109 on the surface of the cover 108 is schematically represented. Note that the touch 109 itself does not generally make direct galvanic connection to the substrate 103 or to the electrodes 101, 102. Rather, the touch influences the electric fields 110 that the measurement circuitry 105 generates using the electrodes 101, 102 (described in more detail below). It should be appreciated that because a touch 109 influences the electric fields, in some implementations, the presence and/or position of a touch above the cover 108 (i.e., without touching the cover 108) is able to be detected and may even be differentiated over a touch 109 that directly touches the cover 108, depending on the sensitivity of the touch-sensitive apparatus 1.

A further aspect of capacitive touch sensors relates to the way the measurement circuitry 105 uses the electrodes of the sensor element 100 to make its measurements. There are two main techniques for measuring capacitance, one or both of which may be employed by the measurement circuitry 105 of the described implementation. That is to say, the measurement circuitry 105 is configured to determine capacitances of one or more of the electrodes of the electrode array using one or both of a first technique and a second technique.

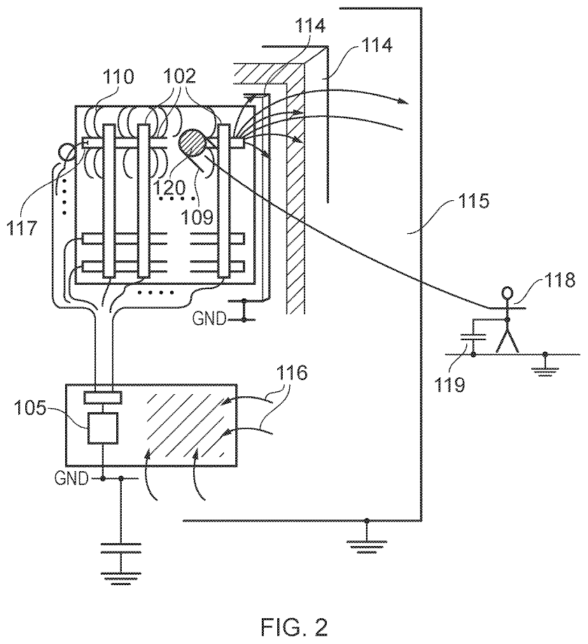

A first technique is based on measuring what is frequently referred to as “self-capacitance”. Reference is made to FIG. 2. In FIG. 2, the measurement circuitry 105 is configured to generate and apply an electrical stimulus (drive signal) to each electrode 101, 102 which will cause an electric field 110 to form around it. This field 110 couples through the space around the electrode back to the measurement circuitry 105 via numerous conductive return paths that are part of the nearby circuitry of the sensor element 100 and the product housing (shown schematically by reference numeral 114), or physical elements from the nearby surroundings 115 etc., so completing a capacitive circuit 116. The overall sum of return paths is typically referred to as the “free space return path” in an attempt to simplify an otherwise hard-to-visualize electric field distribution. The important point to realise is that the measurement circuitry 105 is only driving each electrode from a single explicit electrical terminal 117; the other terminal is the capacitive connection via this “free space return path”. The capacitance measured by the measurement circuitry 105 is the “self-capacitance” of the sensor electrode (and connected tracks) that is being driven relative to free space (or Earth as it is sometimes called) i.e. the “self-capacitance” of the relevant sensor electrode. Touching or approaching the electrode with a conductive element, such as a human finger, causes some of the field to couple via the finger through the connected body 118, through free space and back to the measurement circuitry 105. This extra return path 119 can be relatively strong for large objects (such as the human body), and so can give a stronger coupling of the electrode's field back to the measurement circuitry 105; touching or approaching the electrode hence increases the self-capacitance of the electrode. The measurement circuitry 105 therefore obtains a received signal from the electrode array 101, 102 which indicates an increase in capacitance for the given electrode. The increase is strongly proportional to the area 120 of the applied touch 109 and is normally weakly proportional to the touching body's size (the latter typically offering quite a strong coupling and therefore not being the dominant term in the sum of series connected capacitances).

In the described implementation, the electrodes 101, 102 are arranged on an orthogonal grid, generally with a first set of electrodes on one side of a substantially insulating substrate 103 and the other set of electrodes on the opposite side of the substrate 103 and oriented at substantially 90°to the first set. In other implementations, the electrodes may be oriented at a different angle (e.g., 30°) relative to one another. In addition, it should also be appreciated that it is also possible to provide structures where the grid of electrodes is formed on a single side of the substrate 103 and small conductive bridges are used to allow the two orthogonal sets of electrodes to cross each other without short circuiting. However, these designs are more complex to manufacture and less suitable for transparent sensors. Regardless of the arrangement of the electrodes, broadly speaking, one set of electrodes is used to sense touch position in a first axis that we shall call “X” and the second set to sense the touch position in the second orthogonal axis that we shall call “Y”.

When the measurement circuitry 105 operates in accordance with the self-capacitance measuring mode, the measurement circuitry 105 can either drive each electrode in turn (sequential) with appropriate switching of a single control channel (i.e., via a multiplexer) or it can drive them all in parallel with an appropriate number of separate control channels. In the former sequential case, any neighbouring electrodes to a driven electrode are sometimes grounded by the measurement circuitry 105 to prevent them becoming touch sensitive when they are not being sensed (remembering that all nearby capacitive return paths will influence the measured value of the actively driven electrode). In the case of the parallel drive scheme, the nature of the stimulus applied to all the electrodes is typically the same so that the instantaneous voltage on each electrode is approximately the same. The drive to each electrode is electrically separate so that the measurement circuitry 105 can discriminate changes on each electrode individually, but the driving stimulus in terms of voltage or current versus time, is the same. In this way, each electrode has minimal influence on its neighbours (the electrode-to-electrode capacitance is non-zero but its influence is only “felt” by the measurement circuitry 105 if there is a voltage difference between the electrodes).

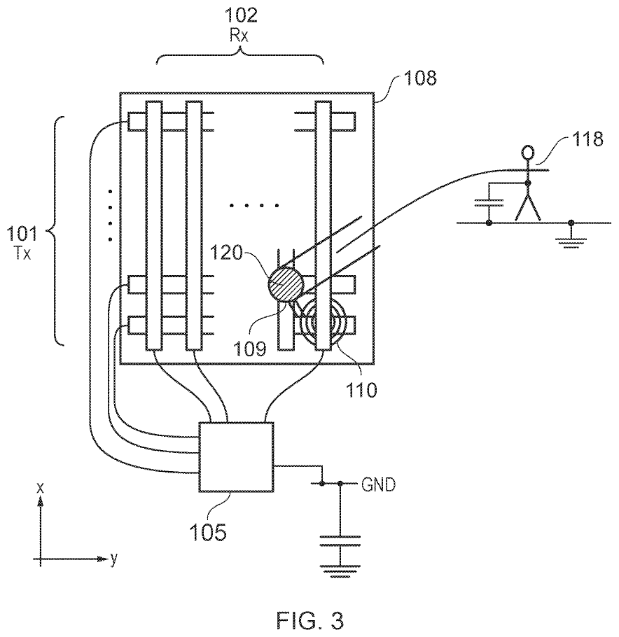

A second technique is based on measuring what is frequently referred to as “mutual-capacitance”. Reference is made to FIG. 3. In FIG. 3, the measurement circuitry 105 will sequentially stimulate each of an array of transmitter (driven/drive) electrodes, shown as the X electrodes 101 in FIG. 3, that are coupled by virtue of their proximity to an array of receiver electrodes, shown as the Y electrodes 102 in FIG. 3. (It should be appreciated that the Y electrodes 102 may instead be the transmitting electrodes and the X electrodes 101 may instead be the receiving electrodes in other implementations). The resulting electric field 110 is now directly coupled from the transmitter to each of the nearby receiver electrodes; the “free space” return path discussed above plays a negligible part in the overall coupling back to the measurement circuitry 105 when the sensor element 100 is not being touched. The area local to and centred on the intersection of a transmitter and a receiver electrode is typically referred to as a “node” or “intersection point”. Now, on application or approach of a conductive element such as a human finger, the electric field 110 is partly diverted to the touching object. An extra return path to the measurement circuitry 105 is now established via the body 118 and “free-space” in a similar manner to that described above. However, because this extra return path acts to couple the diverted field directly to the measurement circuitry 105, the amount of field coupled to the nearby receiver electrode 102 decreases. The measurement circuitry 105 therefore obtains a received signal from the electrode array 101, 102 which indicates a decrease in the “mutual-capacitance” between that particular transmitter electrode and receiver electrodes in the vicinity of the touch 109. The measurement circuitry 105 senses this change in capacitance of one or more nodes. For example, if a reduction in capacitive coupling to a given Y-electrode is observed while a given X-electrode is being driven, it may be determined there is a touch in the vicinity of where the given X-electrode and given Y-electrode cross, or intersect, within the sensing area of the sensor element 100. The magnitude of a capacitance change is nominally proportional to the area 120 of the touch (although the change in capacitance does tend to saturate as the touch area increases beyond a certain size to completely cover the nodes directly under the touch) and weakly proportional to the size of the touching body (for reasons as described above). The magnitude of the capacitance change also reduces as the distance between the touch sensor electrodes and the touching object increases.

As described above, the transmitter electrodes and receiver electrodes in the described implementation are arranged as an orthogonal grid, with the transmitter electrodes on one side of a substantially insulating substrate 103 and the receiver electrodes on the opposite side of the substrate 103. This is as schematically shown in FIG. 3. As in FIG. 2, the first set of transmitter electrodes 101 shown on one side of a substantially insulating substrate 103 and the second set of receiver electrodes 102 is arranged at nominally 90° to the transmitter electrodes on the other side of the substrate 103. In other implementations, the electrodes may be oriented at a different angle (e.g., 30°) relative to one another. In addition, other implementations may have structures where the grid is formed on a single side of the substrate and small insulating bridges, or external connections, are used to allow the transmitter and receiver electrodes to be connected in rows and columns without short circuiting.

There are certain advantages and disadvantages associated with both of the two capacitive sensing techniques described above. Mutual capacitance techniques offer the ability to resolve multiple touches at different locations on the touch-sensitive element. While self-capacitance techniques do not, as a matter of course, provide this functionality, self-capacitance techniques generally output a much stronger signal thus potentially increase the sensitivity of the touch-sensitive apparatus. The measurement circuitry 105 may be configured to operate in either of the self-capacitance and/or mutual capacitance techniques depending on the application at hand.

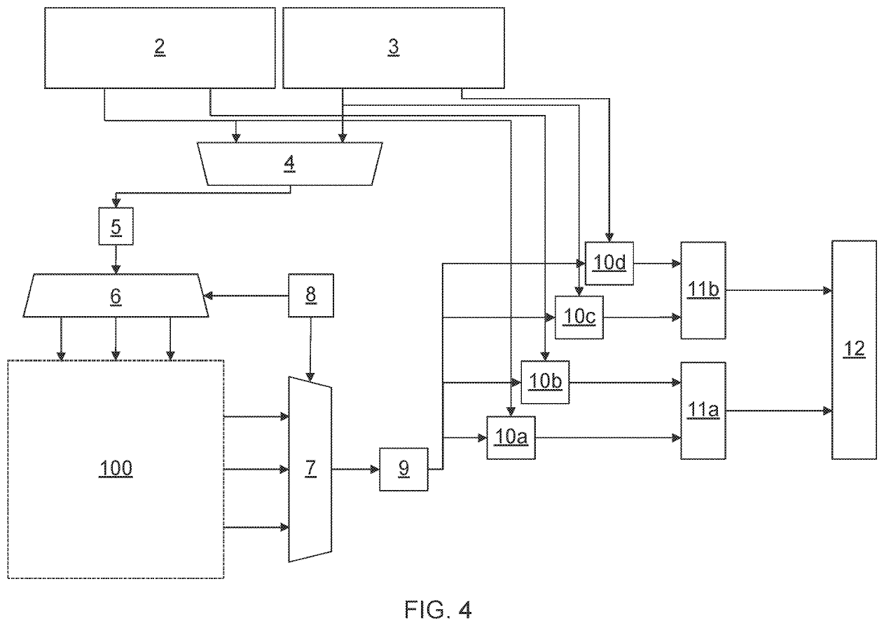

FIG. 4 schematically shows circuitry in accordance with the principles of the present disclosure in more detail.

The circuitry of FIG. 4 comprises a first signal generating module 2, a second signal generating module 3, a drive signal supply multiplexer 4, a digital to analogue converter (DAC) 5, a sensor element drive signal multiplexer/inverter 6, a sensor element receive signal multiplexer/inverter 7, a code generator 8, an analogue to digital converter (ADC) 9, first through fourth multiplier and accumulator modules (MAC) 10a to 10d, first through second memory elements 11a to 11b, and a calculating module 12.

With reference to FIGS. 1 to 3, the circuitry of FIG. 4 is comprised by the measurement circuitry 105 and control circuitry 106. That is to say, various ones of the components described in FIG. 4 are comprised in the measurement circuitry 105 and various ones of the components described in FIG. 4 are comprised in the processing circuitry 106. Additional components not shown in the circuitry of FIG. 4 may also be present in the measurement circuitry 105 and/or processing circuitry 106. In the present example, the measurement circuitry 105 comprises the first signal generating module 2, the second signal generating module 3, the drive signal supply multiplexer 4, the digital to analogue converter (DAC) 5, the sensor element drive signal multiplexer/inverter 6, the sensor element receive signal multiplexer/inverter 7, the code generator 8, and the analogue to digital converter (ADC) 9. Thus, broadly speaking, and as will be discussed in more detail below, the measurement circuitry 105 is responsible for supplying signals (drive signals) to the sensor element 100 (or rather the electrode array 101, 102 thereof) and obtaining signals (receive signals) from the sensor element 100 (or rather electrode array 101, 102 thereof). In the present example, the control circuitry 106 comprises the first through fourth multiplier and accumulator modules (MAC) 10a to 10d, the first through second memory elements 11a to 11b, and the calculating module 12. Thus, broadly speaking, and as will be discussed in more detail below, the control circuitry 106 is responsible for processing the receive signals from the sensor element 100 (supplied by the measurement circuitry 105). It should be appreciated, however, that in other implementations, the distribution of components between the measurement circuitry 105 and control circuitry 106 may be different (e.g., the MACs 10a to 10d may form part of the measurement circuitry 105).

In addition, it should also be noted that FIG. 4 does not show a control element or similar component responsible for controlling the operation of the components within the measurement circuitry 105 or processing circuitry 106. Such a control element or control elements may be provided accordingly based on the implementation at hand. For example, a master control element may be provided as part of the control circuitry 106 or separate from the control circuitry 106 to control the general operations of the circuitry shown in FIG. 4.

Additionally shown in FIG. 4, in highly schematic form is sensor element 100. The sensor element 100 does not form part of the measurement circuitry 105 as such, but instead the measurement circuitry 105 is configured to couple to the sensor element 100. In some implementations however, the measurement circuitry 105 and the sensor element 100 may be integrally formed.

The first signal generating module 2 is configured to generate a first signal. The first signal is representative of a sinusoidal wave having a first frequency, herein denoted F₁. By way of example only, the frequency of the first signal may be approximately 50 kHz. In the implementation described in FIG. 4, the first signal generating module 2 is configured to generate a first digital signal. The term “digital signal” as used herein should be understood to encompass a signal which may take one of a plurality of finite levels (or discrete values) at any given time. This of course is in contrast to an analogue signal which represents a continuous range of possible values. Each of the discrete values of the digital signal may be represented in an appropriate way, for example each discrete value may be represented by a binary or hex code. The “code” herein is generally referred to as a “digital code” to encompass the fact the code could be represented digitally in one of a number of ways, e.g., binary or hex code. Accordingly, as used herein, reference to an “n-bit” digital signal refers to a digital signal that includes an n-bit digital code that represents one of the plurality of discrete values. That is, each of the discrete values may be represented by a specific number of bits; e.g., a 3-bit binary code may represent any one of 2³ (i.e., 8) discrete values. Generally, the greater the number of discrete values to choose from, the greater the possibility of more accurately approximating a continuous analogue signal, such as the sinusoidal analogue wave. In some implementations, a 16-bit digital signal is used, meaning that one of 2¹⁶ (i.e., 65,536) discrete values may be represented by the digital signal at any given moment in time. The digital signal may be thought of as a sequence of digital codes, and thus one or more of the digital codes may be considered to be a portion of the digital signal. The skilled person will appreciate, however, that any suitable way of representing the digital signal may be employed in accordance with the principles of the present disclosure.

The first signal generating module 2 may be provided with any suitable components required to generate and output the first signal representing the sinusoidal wave of frequency F₁. For example, the first signal generating module 2 may comprise a continuous digital sequence e.g., of n-bit binary codes or other suitable codes, each representing one of a series of discrete values located in a memory or the like (i.e., a pre-stored sequence of codes representing the discrete values as a function of time). In the described implementation, the first digital signal is a 16-bit binary digital signal. The first signal generating module 2 therefore comprises 16 separate output lines (not shown), each able to output one of a “1” (e.g., when a voltage pulse is applied to the output line) or a “0 ” (e.g., when a voltage pulse is not applied to the output line) at any given time to output binary codes representing one of the 2¹⁶ possible discrete values. It should be appreciated that the digital signal may be any suitable number of bits and correspondingly the first signal generating module 2 may comprise a corresponding number of output lines.

In the described implementation, the first signal generating module 2 is configured to output the coded sequence at a predetermined rate to generate the first digital signal. The first signal generating module 2 may comprise or receive an output from a clock or oscillator (e.g., associated with a (micro)processor or the like) and be able to reference a look-up table or the like which defines timings at which to output certain codes representing one of the plurality of discrete values. For example, a control element (not shown) may comprise or have access to a (micro)processor and for each clock cycle of the (micro)processor, the first signal generating module 2 is controlled to output one code (e.g., one n-bit binary code) associated with the corresponding discrete value to be output for that clock cycle in accordance with a predefined coded sequence. In some implementations, for example, the clock cycle may be 32 MHz, meaning that one n-bit code (such as a 16-bit binary code) is output around once every 30 ns. Alternatively, the first signal generating module 2 may comprise or receive an output from an oscillator that oscillates at a fixed frequency, and subsequently convert the oscillated signal into a digital representation of said oscillating signal (e.g., using an analogue to digital converter). The skilled person will appreciate that the technique for generating the first digital signal is not significant to the principles of the present disclosure and as such any suitable technique may be implemented in accordance with the principles of the present disclosure.

In addition, the first signal generating module 2 is configured to generate a modified first signal. The modified first signal is identical to the first signal, that is it is representative of a sinusoidal wave having a first frequency F₁, but is phase-shifted compared to the first signal. In the described implementation, the phase shift is set to be 90°. That is, the modified first signal is phase-shifted by 90° relative to the first signal. Hence, the sinusoidal wave represented by the first signal can be expressed by the function sin(ω₁t) or sin(2πF₁t), where ω₁ is the angular frequency corresponding to the frequency F₁, and the sinusoidal wave represented by the modified first signal can be expressed by the function cos(ω₁t) or cos(2πF₁t). It should be appreciated that providing the first signal and the modified first signal which is phased-shifted by 90° provides what is more commonly known as an “in phase” or “I” signal (the first signal) and a “quadrature” or “Q” signal (the modified first signal). Therefore, the first signal may be referred to as the in-phase signal of frequency F₁ and the modified first signal may be referred to as the quadrature signal of frequency F₁.

The first signal generating module 2 may be provided with any suitable components required to generate the modified first signal. In some implementations, the modified first signal may be generated largely independently of the first signal. For example, the first signal generating module 2 may be provided with duplicates of the components used to generate the first signal to subsequently generate the modified first signal, as described above. Alternatively, in other implementations, the modified first signal may be based on the generated first signal. For example, the first signal may be output from the first signal generating module 2 and passed through a component that phase-shifts the first signal (e.g., a suitable component that adds a delay to the first signal) to generate the modified first signal. However, any suitable technique for generating the modified first signal at the first signal generating module 2 may be implemented in accordance with the principles of the present disclosure.

The second signal generating module 3 is configured to generate a second signal. The second signal is representative of a sinusoidal wave having a second frequency, herein denoted F₂. The second frequency F₂ is different from the first frequency F₁. In some implementations, the second frequency F₂ is chosen to be a frequency which provides a reduced crosstalk with the first frequency F₁ when signals of frequency F₁ or F₂ are applied to the electrode array 101, 102. The first and second frequencies F₁, F₂ are set such that a noise signal that causes unacceptable noise on one frequency (e.g., F₁) is unlikely to cause unacceptable noise on the other frequency (e.g., F₂). The extent to which noise couples to a particular signal is dependent on various parameters, including the amplitude and frequency of the noise signal and the measurement signal. Therefore, setting the first and second frequencies to be different by a sufficient amount means that, typically, a source of noise at a given frequency (e.g., X Hz) couples to signals of the first and second frequencies by different amounts. By way of example only, the frequency of the second signal may be approximately 75 kHz.

Additionally, the relative strengths (magnitudes) of the first and second signals and the relative strength of the noise signal should also be borne in mind. In particular, in cases where a signal is applied to an electrode array, the variation between detecting a touch and not detecting a touch may be as low as 1% of the applied signal (that is to say, a touch causes the applied signal to vary by as little as 1%). It should be appreciated that this is merely given as an example, and in other systems the variation (or delta) may be smaller or larger. In such situations, the noise ideally should be less than 0.1%, i.e., a tenth of the delta (providing a signal to noise ratio, SNR, of 1000:1 or less), in order to sufficiently be able to distinguish the change in the applied signal from the noise. It is described later that it is possible to gain an understanding of the degree of noise affecting the first or second signals, but for the sake of describing the characteristics of the first and second signals here, taking the example described above, a crosstalk representing less than 0.05%, i.e., a twentieth of the delta, from the second applied signal means that a signal measurement from the first signal (F₁) does not swamp the noise measurement obtained from the second signal (F₂) or vice versa.

In the implementation described in FIG. 4, the second signal generating module 3 is configured to generate a second digital signal. The second signal generating module 3 may be provided with any suitable components required to generate and output the second signal representing the sinusoidal wave of frequency F₂. For example, the second signal generating module 3 may comprise a continuous digital sequence e.g., of n-bit binary codes or other suitable codes, each representing one of a series of discrete values located in a memory or the like (i.e., a pre-stored sequence of codes representing the discrete values as a function of time). In the described implementation, the second digital signal is a 16-bit binary digital signal. The second signal generating module 3 therefore comprises 16 separate output lines (not shown), each able to output one of a “1” (e.g., when a voltage pulse is applied to the output line) or a “0” (e.g., when a voltage pulse is not applied to the output line) at any given time to output binary codes representing one of the 2¹⁶ possible discrete values. It should be appreciated that the digital signal may be any suitable number of bits and correspondingly the second signal generating module 3 may comprise a corresponding number of output lines.

In the described implementation, the second signal generating module 3 is configured to output the coded sequence at a predetermined rate to generate the second digital signal. The second signal generating module 3 may comprise or receive an output from a clock or oscillator (e.g., associated with a (micro)processor or the like) and be able to reference a look-up table or the like which defines timings at which to output certain codes representing one of the plurality of discrete values. For example, a control element (not shown) may comprise or have access to a (micro)processor and for each clock cycle of the (micro)processor, the second signal generating module 3 is controlled to output one code (e.g., one n-bit binary code) associated with the corresponding discrete value to be output for that clock cycle in accordance with a predefined coded sequence. In some implementations, for example, the clock cycle may be 32 MHz, meaning that one n-bit code (such as a 16-bit binary code) is output around once every 30 ns. Alternatively, the second signal generating module 3 may comprise or receive an output from an oscillator that oscillates at a fixed frequency, and subsequently convert the oscillated signal into a digital representation of said oscillating signal (e.g., using an analogue to digital converter). The skilled person will appreciate that the technique for generating the second digital signal is not significant to the principles of the present disclosure and as such any suitable technique may be implemented in accordance with the principles of the present disclosure.

In addition, the second signal generating module 3 is configured to generate a modified second signal. The modified second signal is identical to the second signal, that is it is representative of a sinusoidal wave having a second frequency F₂, but is phase-shifted compared to the second signal. In the described implementation, the phase shift is set to be 90°. That is, the modified second signal is phase-shifted by 90° relative to the second signal. Hence, the sinusoidal wave represented by the second signal can be expressed by the function sin(ω₂t) or sin(2πF₂t), where ω₂ is the angular frequency corresponding to the frequency F₂, and the sinusoidal wave represented by the modified second signal can be expressed by the function cos(ω₂t) or cos(2πF₂t). It should be appreciated that providing the second signal and the modified second signal which is phased-shifted by 90° provides what is more commonly known as an “in phase” or “I” signal (the second signal) and a “quadrature” or “Q” signal (the modified second signal). Therefore, the second signal may be referred to as the in-phase signal of frequency F₂ and the modified second signal may be referred to as the quadrature signal of frequency F₂.

As above, the second signal generating module 3 may be provided with any suitable components required to generate the modified second signal. In some implementations, the modified second signal may be generated largely independently of the second signal. For example, the second signal generating module 3 may be provided with duplicates of the components used to generate the second signal to subsequently generate the modified second signal, as described above. Alternatively, in other implementations, the modified second signal may be based on the generated second signal. For example, the second signal may be output from the second signal generating module 3 and additionally passed through a component that phase-shifts the second signal (e.g., a suitable component that adds a delay to the second signal) to generate the modified second signal. However, any suitable technique for generating the modified second signal at the second signal generating module 3 may be implemented in accordance with the principles of the present disclosure.

Although the first and second signal generating modules 2, 3 are shown as separate components in FIG. 4, the first and second signal generating modules 2, 3, may be implemented by a single electronic component/circuitry. The first and second signal generating modules 2, 3, may collectively be referred to as a signal generating module.

Referring back to FIG. 4, it can be seen that the output of the first signal generating module 2 and the second signal generating module 3 are input to the drive signal supply multiplexer 4. More specifically, the first digital signal output by the first signal generating module 2 and the second digital signal output by the second signal generating module 3 are input into the drive signal supply multiplexer 4. The drive signal supply multiplexer 4 is configured to selectively output one of the first digital signal or second digital signal received from the first and second signal generating modules 2, 3. That is to say, at any given moment in time, the drive signal supply multiplexer 4 is configured to output either the first digital signal or the second digital signal. The drive signal supply multiplexer 4 may be any component that is suitably capable of selectively outputting one of the first and second digital signals (e.g., a multiplexer or other suitable switching apparatus).

It should be appreciated that, in other implementations, the modified first digital signal or the modified second digital signal may be input to the drive signal supply multiplexer 4 instead of the first digital signal or the second digital signal respectively.

As seen in FIG. 4, outputs from the first and second signal generating modules 2, 3 are also provided to other components, namely the first through fourth MAC modules 10a to 10d, which will be described in more detail later.

The output from the drive signal supply multiplexer 4, which is the first digital signal or the second digital signal according to the described implementation, is passed to the digital-to-analogue converter, DAC, 5. The DAC 5 is configured to convert the first digital signal or second digital signal supplied by the drive signal supply multiplexer 4 to an analogue drive signal capable of being applied to at least one electrode of the sensing element 100. In essence, the DAC 5 is configured to receive the sequence of digital codes output from the drive signal supply multiplexer 4 representing the sequence of discrete values of the first digital signal or second digital signal and convert these discrete values into a smooth analogue signal representing a physical quantity, which in this case is a voltage. The DAC 5 may for instance assign each of the discrete values of the digital signal to a given voltage level at a given time in accordance with the timings of the first or second digital signal. This provides a series of voltage points over time. The DAC 5 may use suitable interpolation techniques, e.g., using a reconstruction filter, to “fill in” the spaces between the series of voltage points to generate a smooth and continuous voltage.

It should be appreciated that digital to analogue conversion (and indeed analogue to digital conversion) can introduce what are known as quantization errors. When mapping an analogue signal to a series of discrete values, an algorithm or set of rules is used to determine which value to use at a given moment in time to represent the value of the analogue signal at that time. For instance, an analogue-to-digital converter, ADC, may sample an analogue signal once every 30 ns (in accordance with a certain sample rate) and determine which discrete value to assign for a corresponding 30 ns period in the digital signal based on the sampled analogue value at that time. Accordingly, this means that a range of analogue values correspond to a single discrete value. The impact of quantization errors can be reduced by having a faster sample rate and/or by increasing the number of available discrete values/bits. However, ADCs/DACs having faster sample rates and increased bits tend to be more expensive, and thus depending on the application at hand, a compromise between cost and accuracy can be made. The DAC 5 in FIG. 4 may comprise any suitable DAC capable of converting the first or second digital signal to an analogue voltage signal.

The analogue voltage signal output by the DAC 5 is subsequently passed to a sensor element drive signal multiplexer/inverter 6. The sensor element drive signal multiplexer/inverter 6 is configured to selectively apply the analogue voltage signal or an inverted version thereof (e.g., a version that is phase-shifted by 180°) to one or more electrodes of the electrode array 101, 102 of the sensor element 100, under control of the code generator 8 described below.

When a drive signal (i.e., the analogue voltage signal) is applied to the sensor element 100, an indication of the capacitance of the sensor element 100 is able to be obtained by the sensor element receive signal multiplexer/inverter 7. The sensor element receive signal multiplexer/inverter 7 is configured to selectively receive a signal from one or more electrodes of the electrode array 101, 102 of the sensor element 100, under control of the code generator 8.

In its simplest form, the code generator 8 supplies instructions to the sensor element drive signal multiplexer/inverter 6 for identifying which electrode(s) of the electrode array are to be provided with the drive signal (or an inversion thereof) and instructions to the sensor element receive signal multiplexer/inverter 7 for identifying which electrode(s) of the electrode array are to be utilised in any measurement. How the sensor element drive signal multiplexer/inverter 6 and the sensor element receive signal multiplexer/inverter 7 are operated will depend in part on the capacitance sensing technique used (e.g., whether a self-capacitance or mutual capacitance sensing technique is used, whether measurements are made in parallel or sequentially, etc.). In the case of a self-capacitance sensing technique, the sensor element receive signal multiplexer/inverter 7 is controlled to obtain a signal from the one or more electrodes that are driven by the sensor element drive signal multiplexer/inverter 6. In the case of a mutual capacitance sensing technique, the sensor element receive signal multiplexer/inverter 7 is controlled to obtain a signal from the one or more receive electrodes that correspond to the electrodes driven by the sensor element drive signal multiplexer/inverter 6. In more detail, and for example assuming one has a grid of four drive electrodes (X-electrodes 101) and four receive electrodes (Y-electrodes 102), the code generator 8 may control the sensor element drive signal multiplexer/inverter 6 to apply the drive signal from the drive signal supply multiplexer 4 to a first X-electrode and control the sensor element receive signal multiplexer/inverter 7 to receive a signal from a first Y-electrode for a first time period, and subsequently control the sensor element drive signal multiplexer/inverter 6 to apply the drive signal to a second X-electrode and control the sensor element receive signal multiplexer/inverter 7 to receive a signal from the first Y-electrode for a second time period, etc. such that the intersections between each X-electrode and each Y-electrode are measured in turn (e.g., in this case there would be sixteen separate measurements).

Although in FIG. 4, only a single multiplexer 6 and a single multiplexer 7 are shown, it should be appreciated that depending on the number of drive and/or receive electrodes 101, 102 in the sensor element, one or more multiplexers 6, 7 may be present depending on how many outputs/inputs each multiplexer comprises.

In accordance with the described implementation, the sensor element drive signal multiplexer/inverter 6 is configured to supply an analogue voltage signal (or an inverted version thereof) to a group of drive electrodes (e.g., a group of X-electrodes 101). That is, the sensor element drive signal multiplexer/inverter 6 is configured to supply an analogue voltage signal (or an inverted version thereof) simultaneously to the electrodes of a group of drive electrodes. The number of electrodes forming the group may depend on the implementation at hand but may be selected from the group comprising: 2, 4, 8, 12, 16, 20, 24, 28, 32, etc. drive electrodes. For the purposes of the present implementation, we will assume that four electrodes are comprised in the group of drive electrodes. It should be appreciated, however, that in some implementations only a single electrode may be driven at any one time.

As seen in FIG. 4, the code generator 8 provides an output to the sensor element drive signal multiplexer/inverter 6. The code generator 8 is configured to provide a code to the sensor element drive signal multiplexer/inverter 6 which is indicative of the signals to be applied to the group of electrodes (i.e., the four drive electrodes) at any given time.

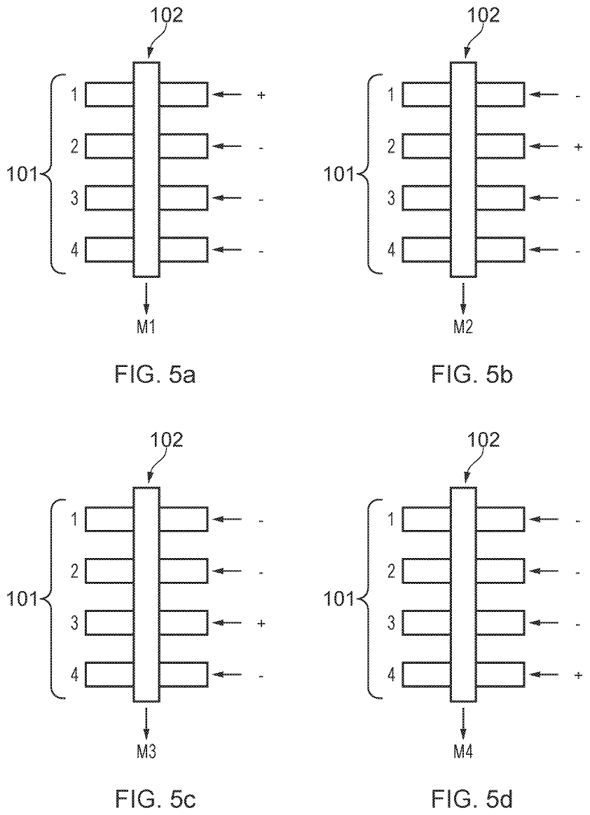

FIGS. 5a to 5d highly schematically illustrate how a group of four drive electrodes (X electrodes 101) labelled 1 to 4 are to be driven in accordance with a suitable output from the code generator 8. For the purposes of this example, it is assumed that the mutual capacitance measurement technique is used and subsequently that there is a single receive electrode (Y-electrode 102). Accordingly, it should be understood that there are four separate locations (intersection points) at which the mutual capacitance can be measured, essentially where each of the four drive electrodes 1 to 4 overlap with the receive electrode 102. For ease of reference, each of these intersection points will be denoted as 102-n where n is the number of the drive electrode (X-electrode 101).

The code generator 8 is configured to output “codes” which act as instructions for driving the group of drive electrodes. More specifically, the codes identify for any given time which drive electrodes are to be driven with the analogue voltage signal and which drive electrodes are to be driven with an inverted analogue voltage signal. The sensor element drive signal multiplexer/inverter 6 is provided with suitable components to apply either the analogue voltage signal or the inverted analogue voltage signal to a given drive electrode. For example, the sensor element drive signal multiplexer/inverter 6 may comprise two channels per drive electrode, with each channel respectively capable of providing one of the non-inverted or inverted voltage signal to the given drive electrode (for example, one channel may comprise a suitable component that adds a delay or phase-shift to the drive signal supplied from the drive signal supply multiplexer 4 via the DAC 5).

FIG. 5a represents the situation where the code generator 8 outputs a first code indicative of electrodes 2 to 4 being driven by the inverted analogue voltage signal output from the DAC 5 and electrode 1 being driven by the non-inverted analogue voltage signal output from the DAC 5. For simplicity, the code communicated to the sensor element drive signal multiplexer/inverter 6 may be represented by the sequence (+1, −1, −1, −1) where “+” and “−” signify the non-inverted analogue voltage signal (“+”) or the inverted analogue voltage signal (“−”) applied to the first through fourth drive electrodes. The drive signals are applied for a certain time period, e.g., T1, and during this time period, the sensor element receive signal multiplexer/inverter 7 receives a signal from the corresponding receive electrode 102. The receive signal is considered to be a measurement (indicative of the capacitances associated with the four intersection points), and thus the sensor element receive signal multiplexer/inverter 7 is subsequently considered to make a first measurement, M1, using the receive electrode 102. The measurement M1 is effectively a summation of signals indicative of the mutual capacitance at the intersection points of the four drive electrodes with the receive electrode.

After the time T1 has elapsed, the code generator 8 may issue another code (a second code) signifying that the non-inverted analogue voltage signal is to be applied to the second drive electrode (electrode 2) and the inverted analogue voltage signal is to be applied to the first, third and fourth electrodes (electrodes 1, 2, and 3), as shown in FIG. 5b. This may be represented by the code (−1, +1, −1, −1). The signals are again applied for a certain time period, e.g., T2, and during this time period, the sensor element receive signal multiplexer/inverter 7 receives a signal from the receive electrode 102. As above, a second measurement M2 being effectively a summation of the signals from the four intersection points is obtained by the sensor element receive signal multiplexer/inverter 7.

The process is repeated where the non-inverted analogue voltage signal is applied to electrode 3 and then electrode 4, while the inverted analogue voltage signal is applied to the remaining electrodes, and measurements M3 and M4 are made using receive electrode, as shown in FIGS. 5c and 5d respectively. These are applied for the time periods T3 and T4, respectively. The time periods T1 to T4 are of the same duration in the present implementation, which may be advantageous for providing symmetry in the obtained measurements, although it should be appreciated that T1 to T4 do not necessarily need to be of the same duration.

It should be understood that during the time periods T1 to T4, the drive signal applied to the drive electrodes 1 to 4 is of a constant frequency, either frequency F₁ or F₂, depending on which drive signal is provided by the drive signal supply multiplexer 4. That is to say, whether the inverted drive signal or the non-inverted drive signal is applied to ones of the group of drive electrodes, the signal that is applied to each of the group of drive electrodes is of the same frequency.

While FIG. 5 only shows four drive electrodes and a single receive electrode, the above process described by FIGS. 5a to 5d may be repeated for additional time periods based on the number of drive electrodes and the number of receive electrodes. For example, when there are more than four drive electrodes, e.g., eight drive electrodes, the code generator 8 is configured to cause the sensor element drive signal multiplexer/inverter 6 to apply the first to fourth codes to a different set of drive electrodes (e.g., electrodes 5 to 8), to obtain measurements M5 to M8. This may be repeated as many times as necessary until all drive signals are applied to all drive electrodes. Equally, when there is more than one receive electrode 102, the code generator 8 is configured to cause the sensor element receive signal multiplexer/inverter 7 to sequentially couple to each of the receive electrodes. For example, after measurements M1 to M4 (or M5 to M8) have been performed, the code generator 8 may output a code to the sensor element receive signal multiplexer/inverter 7 instructing the sensor element receive signal multiplexer/inverter 7 to couple to the second receive electrode 102. The application of the first to fourth codes to the drive electrodes may then be repeated accordingly. It should also be appreciated that the ordering in which the sensor element drive signal multiplexer/inverter 6 and the sensor element receive signal multiplexer/inverter 7 are controlled may be varied from that described above (for example, the first code may be applied for several sequential time periods while the sensor element receive signal multiplexer/inverter 7 switches between each receive electrode, before the second code is applied to the sensor element drive signal multiplexer/inverter 6).

In addition, while the above has shown that four “codes” are applied to a group of four electrodes, it should be appreciated that the four codes may instead be applied to a group of three or even two electrodes. In such a case, four measurements M1 to M4 are still obtained; however, each measurement only contains information (or signals) corresponding to either three or two electrodes. More generally, the number of codes applied to a group of electrodes may be selected from the group comprising: 2, 4, 8, 12, 16, 20, 24, 28, 32, etc., while the number of electrodes in a given group is set to be equal to or less than the number of codes to be applied.

Regardless of whether the mutual-capacitance technique or the self-capacitance technique is used, measurements corresponding to the capacitances of the individual electrodes or pairs of electrodes are obtained by the sensor element receive signal multiplexer/inverter 7. When all measurements are obtained from the sensor element 100 (that is, all the electrodes have been driven and/or all the receive electrodes have been coupled thereto), or when all measurements of a subset of electrodes from the sensor element 100 have been obtained, a scan of the electrode array 101, 102 may be considered complete. This is identified as a “frame”. That is to say, one frame is equivalent to one complete scan of the electrode array or a complete scan of a subset of the electrode array. In this regard, a subset should be understood to be a predefined set of electrodes which might correspond to a particular area of the electrode array (for example, a square region inside the sensing surface) or to a coarser representation of the electrode array (for example, the scan may skip every neighbouring electrode). During any given frame, the drive signal applied to the drive electrodes is of the same constant frequency, e.g., either F₁ or F₂ in the example of FIG. 4. In accordance with the techniques described in more detail below, however, the drive signal applied to consecutive frames is different. That is to say, for a first frame, a drive signal having the first frequency F₁ is applied to the electrode array or subset thereof, while for a second frame, a drive signal having the second frequency F₂ is applied to the electrode array or subset thereof. Accordingly, measurements obtained in the first frame are based on a drive signal having the first frequency F₁ while measurements obtained in the second frame are based on a drive signal having the frequency F₂. This alternating pattern of applying a drive signal of a first frequency followed by a drive signal of a second frequency may be repeated for consecutive frames.

Note also that in some implementations it may be possible to split a frame into sub-frames—e.g., a first group of four by four electrodes are driven with a drive signal having frequency F1 as a first sub-frame, the first group is then driven with a drive signal having a frequency F2 as a second sub-frame, a second group of four by four electrodes are driven with a drive signal having frequency F1 as a third sub-frame, the second group is then driven with a drive signal having frequency F2 as a fourth sub-frame, etc. Measurements from each sub-frame may then be processed accordingly to form a corresponding frame.

Upon receiving the receive signal, the sensor element receive signal multiplexer/inverter 7 passes the receive signal to the analogue to digital converter, ADC, 9. The ADC 9 is broadly configured to work in a similar manner to the DAC 5 but in reverse. That is, the ADC 9 converts the received analogue voltage signal into a digital signal. The output of the ADC 9 is therefore a digital signal representing the received analogue signal output from the electrode(s) of the sensor element 100. The digital signal output by the ADC 9 is herein referred to as the received digital signal as it is a digital representation of the received analogue voltage signal. As should be appreciated in light of the above description, the received digital signal has encoded within it a sinusoidal component that is related to the sinusoidal wave represented by the first or second digital drive signal. The ADC 9 may be configured to output any suitable digital signal. The ADC 9 in FIG. 4 may comprise any suitable ADC capable of converting the received analogue voltage signal to the received digital signal.

The digital received signal output by the ADC 9 is passed to a plurality of multiplier and accumulator (MAC) modules 10a to 10d as seen in FIG. 4. Generally, there are provided two MAC modules for each signal generating module, so in FIG. 4 MAC modules 10a and 10b are provided for the first signal generating module 2 and MAC modules 10c and 10d are provided for the second signal generating module 3. The MAC module 10a is configured to receive the digital received signal output from the ADC 9 in addition to the first digital signal output from the first signal generating module 2. The MAC module 10b is configured to receive the digital received signal output from the ADC 9 in addition to the modified first digital signal output from the first signal generating module 2. The MAC module 10c is configured to receive the digital received signal output from the ADC 9 in addition to the second digital signal output from the second signal generating module 3. The MAC module 10d is configured to receive the digital received signal output from the ADC 9 in addition to the modified second digital signal output from the second signal generating module 3. Although not shown in FIG. 4, in some implementations, before passing to the MAC modules 10a to 10d, the first digital signal output, the modified first digital signal output, the second digital signal output, and the modified second digital signal output may respectively be acted on by a window function (e.g., each signal may be multiplied by the window function). In this way, the MAC modules 10a to 10d utilise a windowed sine function (taking a pulse shape), which modifies the reception spectrum of the system.

Each of the MAC modules 10a to 10d are substantially identical to one another but differ in respect of the inputs they receive, as noted above, and also subsequently differ in the output they provide.

Each of the MAC modules 10a to 10d is configured to firstly multiply the respective inputs (i.e., the digital received signal with one of the first, modified first, second or modified second digital signals). Broadly speaking, the MAC modules 10a to 10d are configured to multiply values of the respective digital signal from the signal generation modules 2, 3 and the received digital signal together at corresponding points in time. Any suitable mechanism may be employed in order to facilitate the multiplication of the two digital signals received at each MAC module 10a to 10d. For example, in some implementations, the MAC modules 10a to 10d may implement a “shift and add” architecture to allow for the relatively rapid multiplication of two binary values using, for example, an interconnected series of adders. Other more advanced techniques, such as the Baugh-Wooley algorithm or Wallace trees, may also be utilised in accordance with the present disclosure. In other implementations, a one-bit-output sigma-delta ADC may be employed as the ADC 9, and the MAC modules 10 to 10d are configured to perform addition or subtraction accordingly. The skilled person will appreciate that any suitable digital multiplication technique may be used in accordance with the present disclosure, and the specific type of digital multiplication technique may depend on a variety of factors including the format of the received digital signal and the first, modified first, second and modified second digital signals.

Secondly, each of the MAC modules 10a to 10d is configured to accumulate the result of the multiplication over a period of time. For example, the multiplication of the two input signals for the MAC modules 10a to 10d may occur at every clock cycle of a (micro)processor, while the MAC modules 10a to 10d may accumulate the results of the multiplication over a time period corresponding, e.g., to the time period over which the received analogue signal is obtained, such as the time period T1, T2, etc. That is, the MAC modules 10a to 10d are configured to accumulate (sum) the plurality of multiplied values over a period of time, which is likely to correspond to a plurality of clock cycles. As should be appreciated, in the described implementation, the MAC modules 10a to 10d may effectively sum each individual multiplication result both for a given clock cycle and for sequential clock cycles. In some implementations, the MAC modules 10a to 10d perform a sequence of additions taking the result of the previous addition operation and using this as the start for the next addition operation. For example, the MAC modules 10a to 10d may comprise a series of binary adders configured to add together the multiplication result.

It should be appreciated that while the MAC modules 10a to 10d shown in FIG. 4 are capable of the functions of both multiplying and accumulating, in other implementations separate components may be provided to perform the multiplication (i.e., multipliers) and to perform the accumulation (i.e., accumulators).

After the predetermined time has elapsed, the MAC modules 10a to 10d output their results of the accumulation to either the first memory element 11a or the second memory element 11b. More specifically, the first and second MAC modules 10a, 10b output their results of accumulation to the first memory element 11a, while the third and fourth MAC modules 10c, 10d output their results of accumulation to the second memory element 11b. In this regard, it should be noted that the MAC modules 10a, 10b corresponding to the first signal generating module 2 output their results of the accumulation to the first memory element 11a, while the MAC modules 10c, 10d corresponding to the second signal generating module 3 output their results of the accumulation to a second memory element 11b. Once sent to the memory elements 11a, 11b, the MAC modules 10a to 10d may reset the accumulators. In some implementations, the transmission of the accumulator results to the memory elements 11a, 11b is performed at the end of the time periods T1, T2, T3, etc. corresponding to the time periods for which a code from code generator 8 is applied to the drive electrodes. Accordingly, the MAC modules 10a to 10d output a result of accumulation corresponding to each code applied to the code drive electrodes.

As will be discussed in greater detail below, the memory elements 11a and 11b output results to the calculating module 12 for various calculation (or processing) of the obtained results.

The accumulation results from the MAC units 10a to 10d provide an indication of the degree to which a given signal (i.e., the received digital signal) correlates with a reference signal (i.e., the first, modified first, second, or modified second digital signal, respectively).

During the first time frame, as noted above, the drive signal driving the electrode array 101, 102 is the first signal having a frequency F₁. In the absence of any touch or object present at the sensing surface of the sensor element 100 or any external electromagnetic noise, the degree to which the received digital signal corresponds to the first digital signal is relatively high. Accordingly, the accumulation result from the first MAC module 10a in this case is also relatively high. In such a case, the accumulation result from the second MAC module 10 b, which receives the modified first digital signal (which is a 90° phase-shifted version of the first digital signal), may also indicate some degree of correlation between the received digital signal and the modified first digital signal, but the magnitude of this correlation is likely to be less given the fact that the reference signal (i.e., the modified first digital signal) is phase-shifted.

In practical terms, even in the absence of a touch and ignoring any noise, there may be a shift in the phase of the received digital signal relative to the first digital signal (as the drive signal) owing to physical path distance (path length) the drive signal and received signal have to travel. That is, it is the received digital signal may be in-phase with the first digital signal, in-phase with the modified first digital signal, or at any other phase shift with respect to the first or modified first digital signal. By providing the second MAC module 10b, which utilises a reference signal (modified first digital signal) that is 90° phased shifted compared to the first digital signal, such phase-shifts can be accounted for. It should be appreciated that the outputs from the MAC modules 10a, 10b can be thought of as corresponding baseband signals of the received digital signal. In principle, any sinusoidal signal can be split (demodulated) into two baseband signals (or conversely any sinusoidal signal can be created using two baseband signals). These baseband signals are the in phase, I, signal and the quadrature, Q, signal, where the quadrature Q signal is 90° out of phase with the in phase I signal. Hence, the first digital signal and the modified first digital signal represent in phase and quadrature baseband signals for the received digital signal, as described above. The baseband signals can be thought of as representing a “real” and “imaginary” part of a sinusoidal signal, and indeed, this is how periodic sinusoidal waves are presented in some branches of mathematics. The process of multiplying the received digital signal and the first or modified first digital signal and accumulating the results essentially performs an IQ demodulation of the received digital signal with respect to the first frequency F₁.

The memory element 11a subsequently stores the accumulation results from the first MAC module 10a and the second MAC module 10b. The memory element 11a outputs the results from the first and second MAC modules 10a, 10b to the calculating module 12 which is capable of performing calculations (or processing) on the transmitted results. In particular, the calculating module 12 is configured to take the output from both the first MAC module 10a and the second MAC module 10b and determine an indication of the magnitude of the component corresponding to the sinusoidal wave represented by the first digital signal (i.e., at the first frequency F₁) in the received digital signal. In other words, the calculating module 12 calculates an indication of the component of the received digital signal at the same frequency as the first digital signal irrespective of any phase shifts (relative to the first digital signal) that the received digital signal has experienced. The magnitude of the received digital signal is measured as it is found that this is the quantity that is modified when a human finger (touch) or object is brought into close proximity to the sensing surface.

Broadly speaking, the magnitude of the received digital signal, with respect to the first digital signal, is represented by the following equation (1):

|Pn|=√(I₁²+Q₁²), (1)

where Pn represents the magnitude of the component corresponding to the sinusoidal wave represented by the first digital signal (of a frequency F₁) in the received digital signal (which is one of measurements M1, M2, M3, etc.), I₁ represents the accumulated value output by the first MAC module 10a (the in phase accumulated value with respect to the first digital signal at frequency F₁) and Q₁ represents the accumulated value output by the second MAC module 10b (the quadrature accumulated value with respect to the first digital signal at frequency F₁).

To implement such a calculation, the calculating module 12 may implement a suitable digital calculation algorithm, for example a CORDIC algorithm (Coordinate Rotation Digital Computer). This process takes advantage of the fact that the I and Q signals can be thought of to represent “real” and “imaginary” parts of the digital signal. The basic premise of the algorithm is to perform a series of phase rotations until the “imaginary” part of the signal tends to zero. The “real” part after the rotations hence represents the magnitude of the signal. This process is particularly effective for calculating the magnitude of a digital signal as it only requires the use of addition/adders to rotate the binary/digital number, rather than multipliers, and hence can reduce the footprint of the electronics.

For the first time period T1, the magnitude of the received digital signal, i.e., |P1|, can be calculated using the above equation (1) based on the output from the first MAC module 10a and the second MAC module 10b at the end of the first time period T1. For the second time period T2, the magnitude of the received digital signal, i.e., |P2|, can be calculated using the above equation (1) based on the output from the first MAC module 10a and the second MAC module 10b at the end of the second time period T2, and so on for the magnitude of the received digital signal at the end of the third time period T3, i.e., |P3|, and at the end of the fourth time period T4, i.e., |P4|.

By the end of the fourth time period T4, the calculating module 12 identifies magnitudes of the received signals P1 to P4 for each of the corresponding time peirods. It should be acknowledged that in view of the measurement process described with respect to FIGS. 5a to 5d, each of the measurements P1 to P4 contain components of the first signal corresponding to all four of the drive electrodes 1 to 4. However, by virtue of being passed through the MAC modules 10a and 10b, the received signals P1 to P4 comprise components of the received signals that couple to the sensor element 100 at (or close to) the first frequency F₁. By using suitable processing, the calculating module 12 is able to identify an indication of the mutual capacitance (in the example of FIG. 5) for each of the intersection points between drive electrodes 1 to 4 and receiver electrode 102. In particular, for the receiver electrode 102, the calculating module 12 is configured to determine the mutual capacitances for the intersection points for electrodes 1 to 4 with receiver electrode 102 using the following equations:

E₁₀₂₋₁(F₁)=P1−P2−P3−P4 (2)

E₁₀₂₋₂(F₁)=P2−P1−P3−P4 (3)

E₁₀₂₋₃(F₁)=P3−P1−P2−P4 (4)

E₁₀₂₋₄(F₁)=P4−P1−P2−P3 (5)

where E₁₀₂₋ₙ(F₁) is an indication of the mutual capacitance for the intersection point between electrode 102 and electrode n of the drive electrodes 101 in respect of the first frequency F₁. Accordingly, the calculating module 12 outputs an indication of the mutual capacitances E102-n(F₁) of the capacitive coupling associated with the driven electrode(s) and/or the receive electrode of the electrode array 101, 102.

In the absence of a touch and any electromagnetic noise that couples to the first drive signal, the values for E₁₀₂₋₁(F₁) to E₁₀₂₋₄(F₁) correspond to a given value, which for ease of reference may be referred to as a static value herein, which may be known in advance to the calculating module 12 through a calibration process or the like. The static values of E₁₀₂₋₁(F₁) to E₁₀₂₋₄(F₁) may be substantially the same or different depending on the structure of the sensor element 100 and/or the touch sensor itself. In some implementations, the static value may be estimated or determined through computer simulation rather than empirical measurements.

In the presence of a touch, and in some instances a source of electromagnetic noise that couples to the first drive signal (e.g., noise that includes a frequency component close to, e.g. with ±20% of, or a multiple of the first frequency F₁), one or more of the values for E₁₀₂₋₁(F₁) to E102-4(F₁) may vary from the static value above, due to a change in the capacitive coupling at the intersection point. When the difference between the measured value and the static value surpasses a threshold, this may be interpreted as indicating the presence of a touch at the respective intersection point. However, as should be appreciated, in some instances, when the source of electromagnetic noise couples at a sufficient level to the receive electrode at the frequency F₁ of the first drive signal, the corresponding capacitance E₁₀₂₋ₙ(F₁) may be affected to such an extent that the calculating module 12 would otherwise incorrectly register a touch at that intersection.

Additionally, during the first time frame, as noted above, the drive signal driving the electrode array 101, 102 is the first signal having a frequency F₁. The second signal having a frequency F₂ is not used to drive the electrodes of the sensor element 100 during the first time frame (indeed, the drive signal supply multiplexer 4 is configured to supply the first drive signal to the sensor element 100 in the first time period). However, as noted above, the MAC module 10c is configured to receive the digital received signal output from the ADC 9 in addition to the second digital signal output from the second signal generating module 3, while the MAC module 10d is configured to receive the digital received signal output from the ADC 9 in addition to the modified second digital signal output from the second signal generating module 3. Because the second digital signal and the modified digital signal are provided at a different frequency to the signal driving the electrodes (i.e., the first signal at frequency F₁ in the first frame), any components of the received signal at the first frequency F₁ have a low correlation with the second digital signal, even when accounting for phase shifts. This includes any touches received at one of the intersection points because any such touches influence the drive signal (at the frequency F₁), or any external electromagnetic noise that couples to the first signal (that is, any electromagnetic noise that may be close to the frequency F₁ or a multiple thereof) is, in effect, not present (or present at a low level) at the frequency F₂.

However, any components of the received digital signal at (or close to) the second frequency F₂ have a high correlation with the second digital signal. Therefore, when the received digital signal includes components at or close to the second frequency F₂, the outputs of the third MAC module 10c and/or the fourth MAC module 10d may be relatively high. For example, any external noise that couples to the sensor element 100 at the second frequency may cause the outputs of the third MAC module 10c and/or the fourth MAC module 10d to be relatively high (or at least high in the context of no noise at or close to frequency F₂ coupling to the sensor element 100).

In a similar manner, the memory element 11b subsequently stores the accumulation results from the third MAC module 10c and the fourth MAC module 10d. The memory element 11b outputs the results from the third and fourth MAC modules 10c, 10d to the calculating module 12 which is capable of performing calculations (or processing) on the transmitted results. In particular, the calculating module 12 is configured to take the output from both the third MAC module 10c and the fourth MAC module 10a and determine an indication of the magnitude of the component corresponding to the sinusoidal wave represented by the second digital signal in the received digital signal. In other words, the calculating module 12 calculates an indication of the component of the received digital signal at the same frequency as the second digital signal irrespective of any phase shifts (relative to the second digital signal) that the received digital signal has experienced. As above, the magnitude of the received digital signal, with respect to the second digital signal, can be represented by the following equation (6), which is noted to be of a similar form to equation (1):

|Nn|=√(I₂²+Q₂²), (6)

where Nn is used to represent the magnitude of the component corresponding to the sinusoidal wave represented by the second digital signal (of a frequency F₂) in the received digital signal, I₂ represents the accumulated value output by the third MAC module 10c (the in phase accumulated value with respect to the second digital signal at frequency F₂) and Q₂ represents the accumulated value output by the fourth MAC module 10d (the quadrature accumulated value with respect to the second digital signal at frequency F₂). As before, the calculating module 12 may implement a suitable digital calculation algorithm, for example a CORDIC algorithm (Coordinate Rotation Digital Computer).

In a similar manner, the magnitude |Nn|, where n represents the time period T1 to T4, can be calculated using the above equation (6) based on the output from the third and fourth MAC modules 10c, 10d for each of the time periods T1 to T4. In an analogous manner to equations (2) to (5) an indication of the mutual capacitance for the intersection point between electrode 102 and electrode n of the drive electrodes 101 with respect to the frequency F2 can be identified using the equations (7) to (10):

E₁₀₂₋₁(F₂)=N1−N2−N3−N4 (7)

E₁₀₂₋₂(F₂)=N2N1N3N4 (8)

E₁₀₂₋₃(F₂)=N3N1N2N4 (9)

E₁₀₂₋₄(F₂)=N4N1N2N3 (10)

Hence, the calculating module 12 similarly outputs an indication of the mutual capacitances E₁₀₂₋ₙ(F₂) of the capacitive coupling associated with the driven electrode(s) and/or the receive electrode of the electrode array 101, 102.

By way of summary, during the first frame (which is comprised of the time periods T1 to T4 in this example), the electrodes or the sensor element 100 are driven by a drive signal of frequency F₁ and a corresponding signal in each of the time periods T1 to T4 is received. The received signal is a combination of signals from each of the drive electrodes (four in this example). The received signal is then processed to obtain a signal representative of the components at frequency F₁ in the received signal for each time period T1 to T4 (using the first and second MAC modules 10a, 10b). These signals are then further processed to identify an indication of the mutual capacitance at each intersection point with the respective drive electrodes with respect to the first frequency F₁. At the same time, the received signal is processed to obtain a signal representative of the components at frequency F₂ in the received signal for each time period T1 to T4 (using the third and fourth MAC modules 10c, 10d). These signals are then further processed to identify an indication of the mutual capacitance at each intersection point with the respective drive electrodes with respect to the second frequency F₂.

Once the above processing is complete, then for a given intersection point (e.g., drive electrode 1 intersecting receive electrode 102) two values representative of the mutual capacitance at that intersection point are provided, one with respect to the first frequency F₁ (the drive frequency) and one with respect to the second frequency F₂ (the non-driven frequency). The mutual capacitance at the intersection point with respect to the first frequency F₁ is based on components in the received signal that couple to the drive signal F₁. Hence, this includes at least the drive signal F₁, but also any touch interactions from the user with the sensor element 100 and any noise components that couple to the sensor element at the first frequency F₁. Conversely, the mutual capacitance at the intersection point with respect to the first frequency F₂ is based on components in the received signal that couple to the non-drive signal F₂. On the assumption that frequency F₂ is selected such that there is no or little coupling of the drive signal (at frequency F₁) to the second frequency F₂, then the mutual capacitance at the given electrode in effect includes only noise components that couple to the sensor element 100 at the second frequency F₂. For ease of reference, the mutual capacitance at the given intersection point with respect to the drive signal (in this case at a frequency F₁), e.g., E₁₀₂₋ₙ(F₁), is referred to herein as a “signal indicative of the presence or absence of a touch” at the intersection point, while the mutual capacitance at the given intersection point with respect to the non-driven signal (in this case at a frequency F₂), e.g., E₁₀₂₋ₙ(F₂), is referred to herein as a “signal indicative of the noise” at the intersection point.

It should be appreciated that external noise that couples at the second frequency F₂ may not have any impact on the mutual capacitance measured at a given intersection point with respect to the first frequency F₁. In other words, if for a given intersection point, the mutual capacitance as measured with respect to frequency F₂ is high, signifying a large amount of noise couples to the sensor element 100 at the second frequency F₂, but this is not indicative of the external noise that couples to the sensor element 100 at the first frequency F₁. However, it is clear that from the measurements of the mutual capacitance of an intersection point at the first frequency F₁, it is not possible to distinguish from this measurement alone whether there are any touch interactions from the user with the sensor element 100 and/or any noise components that couple to the sensor element at the first frequency F₁ that may affect the measurement of the mutual capacitance in respect of the first frequency F₁.

Hence, in accordance with the principles of the present disclosure, after the first time frame has elapsed (and the various measurements obtained), for a second time frame, the circuitry of FIG. 4 is arranged to drive the same electrodes of the sensor element 100 (i.e., drive electrodes 1 to 4 in the described example) using the second drive signal at frequency F₂. That is to say, the drive signal supply multiplexer 4 is configured to supply the second digital signal to digital to analogue converter (DAC) 5, which provides an analogue drive signal having a frequency F₂ to the sensor element drive signal multiplexer/inverter 6. For the second time frame, the sensor element drive signal multiplexer/inverter 6 supplies the drive signal having a frequency F₂ to the respective ones of the drive electrodes of the sensor element 100.

The circuitry of FIG. 4 operates in the same manner as described above in respect of the first frame, except now the MAC modules 10a to 10d receive a signal from the sensor element 100 that is based on the drive signal having a frequency of the second frequency F₂. The calculation module 12 s effectively required to repeat equations (2) to (5) and (7) to (10) based on the outputs from the MAC modules 10a to 10d when the MAC modules receive the signal from the sensor element 100 that is based on the drive signal having a frequency of the second frequency F₂.

Accordingly, for the second time frame (which again, in this example, includes four time periods analogous to time periods T1 to T4), the first and second MAC modules 10a, 10b receive the received digital signal (from the sensor element 100 that is based on the drive signal having a frequency of the second frequency F₂) and multiply the received digital signal by either the first digital signal or the modified first digital signal. The memory element 11a subsequently stores the accumulation results from the first MAC module 10a and the second MAC module 10b and outputs the results from the first and second MAC modules 10a, 10b to the calculating module 12. The calculating module 12 similarly takes the output from both the first MAC module 10a and the second MAC module 10b and performs processing on the values (e.g., according to equation (1) and then followed by equations (2) to (5) described above).

However, unlike in the first time frame, the drive signal driving the electrodes of the sensor element 100 is at frequency F₂ which is different to the frequency F₁ of the first digital signal and the modified first digital signal. The IQ demodulation performed by the first and second MAC modules 10a, 10b and the calculating module 12 therefore provides a measure of the correlation of the received digital signal to the drive signal at the frequency F₂. Accordingly, for the second time frame, because the received signal has a low correlation with the drive signal at frequency F₂, the values for E₁₀₂₋₁(F₁) to E₁₀₂₋₄(F₁) correspond predominantly to external noise that is coupled to the sensor element 100 at or close to the frequency F₁. The values for E₁₀₂₋₁(F₁) to E₁₀₂₋₄(F₁) in the second time frame will either not have components that couple to the drive signal (at frequency F₂) or have a low coupling to the drive signal (at frequency F₂). In other words, the values for E₁₀₂₋₁(F₁) to E₁₀₂₋₄(F₁) in the second time period are indicative of the external noise that couples to the sensor element 100 at or close to the frequency F₁ in the second frame.

Additionally, for the second time frame, the third and fourth MAC modules 10c, 10d receive the received digital signal (from the sensor element 100 that is based on the drive signal having a frequency of the second frequency F₂) and multiply the received digital signal by either the second digital signal or the modified second digital signal. The memory element 11b subsequently stores the accumulation results from the third MAC module 10c and the fourth MAC module 10d and outputs the results from the third and fourth MAC modules 10c, 10d to the calculating module 12. The calculating module 12 similarly takes the output from both the third MAC module 10c and the fourth MAC module 10d and performs processing on the values (e.g., according to equation (6) and then followed by equations (7) to (10) described above).

The drive signal driving the electrodes of the sensor element 100 is at frequency F₂ which is the same as the frequency F₂ of the second digital signal and the modified second digital signal. The IQ demodulation performed by the third and fourth MAC modules 10c, 10d and the calculating module 12 therefore provides a measure of the correlation of the received digital signal to the drive signal at the frequency F₂. Accordingly, for the second time frame, because the received signal has a high correlation with the drive signal at frequency F₂, the values for E₁₀₂₋₁(F₂) to E₁₀₂₋₄(F₂) correspond to a combination of the drive signal, any effects a user's touch has on the drive signal and/or any external noise that is coupled to the sensor element 100 at or close to the frequency F₂. In other words, the values for E₁₀₂₋₁(F₂) to E₁₀₂₋₄(F₂) in the second time period are indicative of the presence or absence of a touch in addition to any external noise that couples to the sensor element 100 at or close to the frequency F₂ in the second frame.

Hence, over the course of the two time frames, it should be appreciated that at each frequency F₁ or F₂, the calculating module 12 is configured to provide separate measurements of the mutual capacitance at the various intersection points, E₁₀₂₋ₙ(F₁/F₂), whereby one measurement is indicative of the mutual capacitance corresponding to the drive signal at a given frequency, any touch influences and any external noise at the given frequency, while the other measurement is indicative of the mutual capacitance substantially corresponding to any external noise at the same frequency. Accordingly, the calculating module 12 (and/or any other control circuitry) is configured to utilise the measurement indicative of noise obtained in one time frame to assess the degree of noise affecting the measurement indicative of the presence or absence of a touch obtained in the other time frame.

For example, in the first time frame, the mutual capacitance value E₁₀₂₋ₙ(F₁) obtained in the first time frame is indicative of the mutual capacitance at the intersection point between drive electrode n and receive electrode 102 of the electrode array. As the drive signal in the first time frame has a frequency F₁, the mutual capacitance value E₁₀₂₋ₙ(F₁) obtained in the first time frame includes components relating to the drive signal as well potentially any components relating to the interaction of a user with the sensor element 100 (i.e., whether a touch is present or absent at the intersection point) and/or any noise that couples to the sensor element 100 at (or close to) frequency F₁. In the second time frame, as the drive signal in the second time frame has a frequency F₂, the mutual capacitance value E₁₀₂₋ₙ(F₁) obtained in the second time frame predominantly includes components relating to any noise that couples to the sensor element 100 at (or close to) frequency F₁. Accordingly, if the difference between the mutual capacitance value E₁₀₂₋ₙ(F₁) obtained in the first time frame and a corresponding static value obtained in advance for the given intersection point surpasses a threshold (which may be considered indicative of the presence of a touch at the sensor element 100), the calculating module 12 (or other control circuitry) can use the mutual capacitance value E₁₀₂₋ₙ(F₁) obtained in the second time frame to assess a reliability of the determination of the presence or absence of a touch. Put another way, the calculating module 12 (or other control circuitry) can use the mutual capacitance value E₁₀₂₋ₙ(F₁) obtained in the second time frame to estimate a degree of noise affecting the mutual capacitance value E₁₀₂₋ₙ(F₁) obtained in the first time frame.

For instance, if the difference between the mutual capacitance value E₁₀₂₋ₙ(F₁) obtained in the first time frame and a corresponding static value obtained in advance for the given intersection point surpasses the threshold and the value E₁₀₂₋ₙ(F₁) obtained in the second time frame indicates a low degree of noise, the calculating module 12 may consider the determination of a touch at the sensor element 100 to be reliable and output a corresponding signal indicative of such (e.g., to associated control circuitry). Conversely, if the difference between the mutual capacitance value E₁₀₂₋ₙ(F₁) obtained in the first time frame and a corresponding static value obtained in advance for the given intersection point surpasses the threshold and the mutual capacitance value E₁₀₂₋ₙ(F₁) obtained in the second time frame indicates a high degree of noise, the calculating module 12 may consider the determination of a touch at the sensor element 100 to be unreliable and may be configured to not output a corresponding signal indicative of the presence of a touch in this instance. Hence, the calculating module 12 is capable of determining the reliability of the determination of the presence/absence of a touch at the sensor element 100.

It should be appreciated that although above it has been described that the calculating module 12 first determines whether the difference between the mutual capacitance value E₁₀₂₋ₙ(F₁) obtained in the first time frame and the static mutual capacitance obtained in advance exceeds a threshold before using the mutual capacitance value E₁₀₂₋ₙ(F₁) obtained in the second time frame to determine the degree of noise affecting the mutual capacitance value E₁₀₂₋ₙ(F₁) obtained in the first time frame (and thus the reliability of the determination), in other implementations the calculating module 12 may use the mutual capacitance value E₁₀₂₋ₙ(F₁) obtained in the second time frame to determine the degree of noise affecting each mutual capacitance value E₁₀₂₋ₙ(F₁) obtained in the first time frame.

It should be appreciated that the value of the mutual capacitance E₁₀₂₋ₙ(F₁) obtained in the first time frame is obtained at a different time to the value of the mutual capacitance E₁₀₂₋ₙ(F₁) obtained in the second time frame. Therefore, the mutual capacitance E₁₀₂₋ₙ(F₁) obtained in the second time frame (indicative of the noise) is actually obtained at a later time than the mutual capacitance E₁₀₂₋ₙ(F₁) obtained in the first time frame (indicative of the presence/absence of a touch). Therefore, the mutual capacitance E₁₀₂₋ₙ(F₁) obtained in the second time frame is a measure of the noise at or close to frequency F₁ that is coupled to the sensor element during the second time frame, not necessarily during the first time frame. However, in practical implementations, by making the first time frame and the second time frame relatively short and such that the second time frame immediately follows the first time frame means, the indication of noise obtained in the second time frame can be considered a good approximation for the noise (at or close to the frequency F₁) that couples to the sensor element 100 during the first time frame.

Additionally, it should be appreciated that by providing the third and fourth MAC modules 10c, 10d and by performing the processing as describe above, the circuitry of FIG. 4 includes a second set of measurements or values of the mutual capacitance. Namely, these are the values E₁₀₂₋ₙ(F₂) obtained in the first time frame and E₁₀₂₋ₙ(F₂) obtained in the second time frame. These values are obtained at no extra cost in respect of time. That is to say, regardless whether this second set of measurements or values of mutual capacitance are obtained or not, the time taken to obtain the values E₁₀₂₋ₙ(F₁) obtained in the first time frame and E₁₀₂₋ₙ(F₁) obtained in the second time frame is the same (i.e., the duration of the first time frame plus the second time frame). However, the second set of values can be used by the calculating module 12 in the event that, for example, the calculating module determines the values E₁₀₂₋ₙ(F₁) obtained in the first time frame is unreliable (that is, has a high degree of noise) for use in determining whether or not a touch is present at the sensor element 100.

For example, in the first time frame, the mutual capacitance value E₁₀₂₋ₙ(F₂) obtained in the first time frame predominantly includes components relating to any noise that couples to the sensor element 100 at (or close to) frequency F₂. In the second time frame, the mutual capacitance value E₁₀₂₋ₙ(F₂) obtained in the second time frame includes components relating to the drive signal (which is the second drive signal provided at frequency F₂ in the second time frame), and potentially any interaction between the user and the intersection point of the sensor element 100 and any noise that couples to the sensor element 100 at (or close to) frequency F₂, In a similar manner as describe above in respect of the mutual capacitance values E₁₀₂₋ₙ(F₁), if the difference between the mutual capacitance value E₁₀₂₋ₙ(F₂) obtained in the second time frame and a corresponding static value obtained in advance for the given intersection point surpasses a threshold (which may be considered indicative of the presence of a touch at the sensor element 100), the calculating module 12 (or other control circuitry) can use the mutual capacitance value E₁₀₂₋ₙ(F₂) obtained in the first time frame to assess a reliability of the determination of the presence or absence of a touch. Put another way, the calculating module 12 (or other control circuitry) can use the mutual capacitance value E₁₀₂₋ₙ(F₂) obtained in the first time frame to estimate a degree of noise affecting the mutual capacitance value E₁₀₂₋ₙ(F₂) obtained in the second time frame.

Accordingly, the calculating module 12 is able to make use of the second set of measurements (i.e. E₁₀₂₋ₙ(F₂) in the first frame and the second frame), if desired. For example, if the calculating module 12 determines that the difference between the mutual capacitance value E₁₀₂₋ₙ(F₁) obtained in the first time frame and a corresponding static value obtained in advance for the given intersection point surpasses the threshold and the value E₁₀₂₋ₙ(F₁) obtained in the second time frame indicates a high degree of noise (which as described above would lead the calculating module 12 to determine that the determination of a touch at the sensor element 100 is unreliable), the calculating module 12 may be configured to determine whether the value E₁₀₂₋ₙ(F₂) obtained in the first time frame indicates a low degree of noise at the frequency F₂, and if so, the calculating module 12 may determine whether the difference between the mutual capacitance value E₁₀₂₋ₙ(F₂) obtained in the second time frame and a corresponding static value obtained in advance for the given intersection point surpasses the threshold. If so, the calculating module 12 may output a signal indicative of a touch being sensed at the sensor element 100.

Alternatively, the calculating module 12 may be configured to determine for a given intersection point:
1. the difference between the mutual capacitance value E₁₀₂₋ₙ(F₁) obtained in the first time frame and a corresponding static value obtained in advance for the given intersection point surpasses the threshold, and if so, the reliability of the mutual capacitance value E₁₀₂₋ₙ(F₁) obtained in the first time frame by using the mutual capacitance value E₁₀₂₋ₙ(F₁) obtained in the second time frame; and
2. the difference between the mutual capacitance value E₁₀₂₋ₙ(F₂) obtained in the second time frame and a corresponding static value obtained in advance for the given intersection point surpasses the threshold (which may be different than the threshold above), and if so, the reliability of the mutual capacitance value E₁₀₂₋ₙ(F₂) obtained in the second time frame by using the mutual capacitance value E₁₀₂₋ₙ(F₂) obtained in the first time frame;

For a given intersection point, if the calculating module 12 determines that the respective thresholds are surpassed at items 1 and 2 above, if any one or both of the measurements are determined to be reliable based on the mutual capacitance value E₁₀₂₋ₙ(F₁) obtained in the second time frame and the mutual capacitance value E₁₀₂₋ₙ(F₂) obtained in the first time frame, respectively, the calculating module 12 outputs a signal (e.g., to associated circuitry) indicative of the detection of a touch at the given intersection point.

Hence, there has been described circuitry for a touch sensitive apparatus 1, wherein the circuitry is configured to apply a first (drive) signal to one or more electrodes 101 of an electrode array 101, 102 for a first time period (or first time frame) and obtain a first received signal (e.g., M1 to M4 during the first time period) from the electrode array 101, 102 while the first (drive) signal is applied to the electrode array 101,102 for the first time period. In addition, the circuitry is configured to apply a second (drive) signal—at a different frequency to the first (drive) signal—to one or more electrodes of an electrode array for a second time period (or second frame) and obtain a second received signal (e.g., M1 to M4 during the second time period) from the electrode array 101, 102 while the second signal is applied to the electrode array 101, 102 for the second time period.

The circuitry (e.g., the calculating module 12) is further configured to determine whether a touch or object has been detected at the sensing element 100 based on the result of applying the first (drive) signal to the first received signal (e.g., to obtain the value E₁₀₂₋ₙ(F₁) obtained in the first time period) and/or applying the second (drive) signal to the second received signal (e.g., to obtain the value E₁₀₂₋ₙ(F₂) obtained in the second time period). It has been described above that the first or second received signal is applied to two pairs of MAC modules (a first pair comprising the first and second MAC modules 10a, 10b, and a second pair comprising the third and fourth MAC modules 10c, 10d) and each pair of MAC modules applies either the first/second drive signal and a modified first/second drive signal. The pairs of MAC modules are provided to account for any phase shifts between the applied drive signal and the received signal. However, in some implementations, the received signal may not experience a phase shift and thus only one of the pairs of MAC modules 10a to 10d may be provided.

Additionally, determining whether a touch or object has been detected at the sensing element 100 is further based on an indication of the noise associated with the first received signal and/or second received signal, respectively. An indication of the noise associated with the first received signal is obtained by applying the first (drive) signal to the second received signal (e.g., to obtain the value E₁₀₂₋ₙ(F₁) in the second frame) and wherein an indication of the noise associated with the second received signal is obtained by applying the second signal to the first received signal (e.g., to obtain the value E₁₀₂₋ₙ(F₂) in the first frame). The circuitry, when determining whether a touch or object has been detected at the sensor element 100, determines a difference between the result of applying the first signal to the first received signal (e.g., E₁₀₂₋ₙ(F₁) obtained in the first frame) and/or the second signal to the second received signal (e.g., E₁₀₂₋ₙ(F₂) obtained in the second time frame) to a reference value (i.e. the aforementioned static value) determined in advance. It should be appreciated that the reference value determined in advance is a reference value indicative of no touch present at the sensing element 100. In addition, the reference value may differ depending on the drive signal (i.e., the first drive signal at frequency F₁ or the second drive signal at frequency F₂). Additionally, the reference value may differ for each intersection point and be set individually.

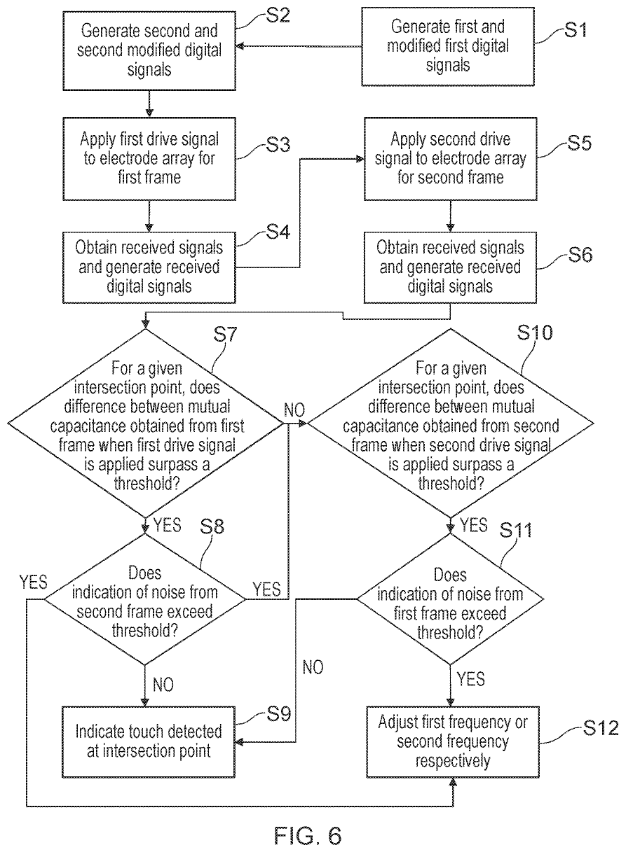

FIG. 6 shows a flow diagram depicting an example method in accordance with the principles of the present disclosure.

The method starts at step S1 with the generation of the first and modified first digital signals using the first digital signal generation module 2. As specified previously, the first and modified first digital signals may be a sequence of digital codes, each digital code corresponding to one of a plurality of finite values. The first digital signal represents a sinusoidal wave of a first frequency F₁ and the modified first digital signal represents a sinusoidal wave of the first frequency F₁ but phase shifted (e.g., by 90°).

The method proceeds to step S2 with the generation of the second and modified second digital signals using the second digital signal generation module 3. As specified previously, the second and modified second digital signals may be a sequence of digital codes, each digital code corresponding to one of a plurality of finite values. The second digital signal represents a sinusoidal wave of a second frequency F₂ and the modified second digital signal represents a sinusoidal wave of the second frequency F₂ but phase shifted (e.g., by 90°).

The method the proceeds to step S3 where, for a first time period (or first frame), a drive signal having the first frequency F₁ (or an inverted version thereof) is applied to one or more electrodes of the electrode array of the sensor element 100. In this step, the first digital signal is supplied by the drive signal multiplexer 4 to the DAC 5 as described above to form an analogue drive signal. The sensor element drive signal multiplexer/inverter 6 is configured to apply the analogue drive signal or an inversion thereof to selected ones of the drive electrodes 101 of the electrode array 101, 102 in accordance with a suitable control or measurement scheme, e.g., such as the technique shown in FIGS. 5a to 5d.

At step S4, the received digital signals are generated for the first frame. As should be appreciated, multiple measurements, M1 to M4 (i.e., multiple received signals), may be obtained by the sensor element receive signal multiplexer/inverter 7 at the first time frame and subsequently converted from received analogue signals to received digital signal via an analogue to digital converter (ADC) 9.

The method then proceeds to step S5, where, for a second time period (or second frame), a drive signal having the second frequency F₂ (or an inverted version thereof) is applied to one or more electrodes of the electrode array of the sensor element 100 (and in particular, the same one or more electrodes to which the drive signal have a frequency F₁ is applied in step S3). In particular, the second digital signal is supplied by the drive signal multiplexer 4 to the DAC 5 as described above to form an analogue drive signal. The sensor element drive signal multiplexer/inverter 6 is configured to apply the analogue drive signal or an inversion thereof to selected ones of the drive electrodes 101 of the electrode array 101, 102 in accordance with a suitable control or measurement scheme, e.g., such as the technique shown in FIGS. 5a to 5d.

At step S6, the received digital signals are generated for the second frame. As should be appreciated, multiple measurements, M1 to M4 (i.e., multiple received signals), may be obtained by the sensor element receive signal multiplexer/inverter 7 in the second frame and subsequently converted from received analogue signals to received digital signal via an analogue to digital converter (ADC) 9.

The method then proceeds to step S7. Step S7 encompasses part of the processing performed by the MAC modules 10a to 10d, first and second memory elements 11a, 11b and the calculating module 12. The way in which the various mutual capacitance values are obtained, namely E₁₀₂₋ₙ(F₁) for the first and second frames and E₁₀₂₋ₙ(F₂) for the first and second frames, is described in detail above. Assuming these mutual capacitance values have been calculated, at step S7 the calculating module 12 is configured to determine, for a given intersection point (i.e. a given drive electrode and a corresponding receive electrode), whether the difference between the mutual capacitance value obtained during the first frame (when the drive signal of the first frequency F₁ is applied), i.e., E₁₀₂₋ₙ(F₁) for the first frame, and a reference value surpass a threshold value.

If at step S7, the answer is YES, the method proceeds to step S8. At step S8, the calculating module 12 is configured to compare the mutual capacitance indicative of noise at the first frequency F₁ obtained from measurements made in the second frame, i.e., the value E₁₀₂₋ₙ(F₁) for the second frame, to a threshold. At step S8, if the mutual capacitance indicative of noise at the first frequency F₁ does not exceed the threshold (i.e., a NO at step S8), then the calculating module 12 may be programmed to output a signal (e.g., to associated control circuitry) indicative of the presence of a touch detected at the intersection point (at step S9). The method may end here or is repeated for each intersection point and/or for multiple scans of the electrode array (either by going back to step S7 or step S3 respectively).

If at step S7, the answer is NO, and/or at step S8, the answer is YES, the method may proceed to step S10. Step S10 is similar to step S7. Again, assuming the mutual capacitance values have been calculated as described above, at step S10 the calculating module 12 is configured to determine, for the given intersection point (i.e. a given drive electrode and a corresponding receive electrode), whether the difference between the mutual capacitance value obtained during the second frame (when the drive signal of the second frequency F₂ is applied), i.e., E₁₀₂₋ₙ(F₂) for the second frame, and a reference value surpass a threshold value. As noted above, the reference value may or may not be the same as the reference value in step S7.

If at step S10, the answer is YES, the method proceeds to step S11. Step S11 is similar to step S8. At step S11, the calculating module 12 is configured to compare the mutual capacitance indicative of noise at the second frequency F₂ obtained from measurements made in the first frame, i.e., the value E₁₀₂₋ₙ(F₂) for the first frame, to a threshold. The threshold may be the same or different from the threshold at step S8. At step S11, if the mutual capacitance indicative of noise at the second frequency F₂ does not exceed the threshold (i.e., a NO at step S11), then the calculating module 12 may be programmed to output a signal (e.g., to associated control circuitry) indicative of the presence of a touch detected at the intersection point (at step S9). The method may end here or is repeated for each intersection point and/or for multiple scans of the electrode array (either by going back to step S7/S10 or step S3 respectively).

It should be appreciated that the method described above is intended to be performed a plurality of times. In this regard, the method is performed a plurality of times for a single scan of the electrode array (that is, for each of the intersection points). Steps S3 to S6 may be performed for each and every intersection point (including in groups of drive electrodes as described above) before steps S7 and S10 are performed, or alternatively a subset of the measurements for an entire scan of the electrode array may be performed and steps S7 and S10 performed for this subset, before another subset of measurements (relating to different electrodes) is obtained. Regardless, steps S7 and S10 are repeated for each intersection point, and this may be the case regardless of the answer to steps S7 and S10. That is to say, regardless of whether steps S7 and/or step S10 are answered in the affirmative or the negative, steps S7 and S10 may be repeated for each and every intersection point. In addition, the method may be repeated for a plurality of scans of the electrode array. That is, once steps S7 and S10 have been performed for a single scan, steps S3 to S6 are performed for a second (and subsequent) scan and correspondingly steps S7 and S10 are repeated accordingly.

Although the method of FIG. 6 shows step S7 going to step S10, it may be that in other implementations, the method does not proceed to step S10 until first going to step S8. In addition, in other implementations, after step S6, steps S7 and S10 may be performed simultaneously.

Optionally, in some implementations, if step S8 and/or step S11 is answered in the positive, the method may proceed to step S12. To recap, if steps S8 or S11 are answered in the positive, this means that the respective comparison step suggests that there is a high degree of noise in the measurements at the first frequency (step S8) or the second frequency (step S11). If the degree of noise at a particular frequency is determined to be high, then the circuitry (for example, the first or second signal generating modules 2, 3) is configured to adjust either the first frequency or the second frequency. In this way, if it is considered that the effect of noise at either of the first and second frequencies effects the measurements of the mutual capacitance, then by adjusting the frequency, the effect of the noise may be reduced (depending on the frequency of the noise) for subsequent measurements. In some implementations, the circuitry may be configured to proceed to step S12 when step S8 and/or step S11 are answered in the positive a predetermined number of times within a predetermined time period. For example, if step S8 is answered in the affirmative say, twenty times, in a period of say 0.5 seconds, then the method may proceed to step S12. This may avoid adjusting the frequency too often.

In other implementations, when one of steps S8 or S11 is answered in the affirmative (either once or for a predetermined number of times and in a predetermined time period), the circuitry (calculating module 12) may be configured to stop performing calculations for that frequency. For example, if step S8 is answered in the affirmative, the calculating unit 12 may be configured to stop executing steps S7 and S8 and instead only execute steps S10 and S11. This halting of steps S7 to S8 may be temporary; for example, for a predetermined time period or until the touch apparatus 1 is switch off and back on again.

It has been described above that the sinusoidal waves on which the first digital signal and second digital signal are based are of a single frequency. In some examples, the single frequency may be in the range of 25 kHz to 250 kHZ, although it should be appreciated that this is an example only and other frequencies may be used in other implementations. A particularly advantageous reason for using sinusoidal signals of a single frequency is that the majority of the energy applied to the electrode array is in the fundamental frequency. Having multiple frequencies means that the electrode array, which essentially acts as a low-pass filter, causes some of the energy in the higher frequencies to be lost to the system as a whole. In other words, more of the energy is retained when using a single frequency which results in a stronger signal obtained from the electrode array. While, as mentioned, there is the possibility of some additional frequency components being introduced as a result of the quantization errors or the like, these generally speaking would only contain a relatively small fraction of the energy of the overall drive signal.

Thus there has been described circuitry for a touch-sensitive apparatus including a first signal generating module configured to generate a first signal representing a sinusoidal wave having a first frequency; a second signal generating module configured to generate a second signal representing a sinusoidal wave having a second frequency, the second frequency being different to the first frequency; and processing circuitry configured to perform processing on one or more received signals. The circuitry is configured to: apply the first signal to one or more electrodes of an electrode array for a first time period and obtain a first received signal from the electrode array while the first signal is applied to the electrode array for the first time period, apply the second signal to one or more electrodes of an electrode array for a second time period and obtain a second received signal from the electrode array while the second signal is applied to the electrode array for the second time period, and determine whether a touch or object has been detected at a sensing surface corresponding to the electrode array based on the result of applying the first signal to the first received signal and/or applying the second signal to the second received signal. Determining whether a touch or object has been detected at the sensing surface is further based on an indication of the noise associated with the first received signal and/or second received signal, wherein an indication of the noise associated with the first received signal is obtained by applying the first signal to the second received signal and wherein an indication of the noise associated with the second received signal is obtained by applying the second signal to the first received signal. Also described is a touch-sensitive apparatus including the circuitry and a method for determining the presence of a touch or object at a touch-sensitive apparatus.

Further particular and preferred aspects of the present invention are set out in the accompanying independent and dependent claims. It will be appreciated that features of the dependent claims may be combined with features of the independent claims in combinations other than those explicitly set out in the claims.

1. Circuitry for a touch-sensitive apparatus, the circuitry comprising:
a first signal generating module configured to generate a first signal representing a sinusoidal wave having a first frequency;
a second signal generating module configured to generate a second signal representing a sinusoidal wave having a second frequency, the second frequency being different to the first frequency; and
procecharssing circuitry configured to perform processing on one or more received signals,
wherein the circuitry is configured to:
apply the first signal to one or more electrodes of an electrode array for a first time period and obtain a first received signal from the electrode array while the first signal is applied to the electrode array for the first time period,
apply the second signal to one or more electrodes of an electrode array for a second time period and obtain a second received signal from the electrode array while the second signal is applied to the electrode array for the second time period, and
determine whether a touch or object has been detected at a sensing surface corresponding to the electrode array based on the result of applying the first signal to the first received signal and/or applying the second signal to the second received signal, wherein
determining whether a touch or object has been detected at the sensing surface is further based on an indication of the noise associated with the first received signal and/or second received signal, wherein an indication of the noise associated with the first received signal is obtained by applying the first signal to the second received signal and wherein an indication of the noise associated with the second received signal is obtained by applying the second signal to the first received signal.

2. The circuitry of claim 1, wherein determining whether a touch or object has been detected at the sensing surface comprises determining a difference between the result of applying the first signal to the first received signal and/or the second signal to the second received signal to a reference value determined in advance.

3. The circuitry of claim 2, wherein the reference value determined in advance is a reference value indicative of no touch present at the sensing surface.

4. The circuitry of claim 1, wherein when the indication of the noise associated with the first received signal or when the indication of the noise associated with the second received signal surpasses a threshold, the circuitry is configured to adjust the first frequency or the second frequency respectively to reduce the indication of noise.

5. The circuitry of claim 4, wherein when the circuitry is in the process of adjusting the first frequency or second frequency, the other of the first frequency or second frequency is maintained and the circuitry is configured to determine whether a touch or object has been detected at the sensing surface corresponding to the electrode array based on the result of applying the other of the first signal to the first received signal or the second signal to the second received signal.

6. The circuitry of claim 1, wherein when the indication of the noise associated with the first received signal surpasses a threshold, the circuitry is configured to apply the second signal to the one or more electrodes for the first time period and second time period, or wherein when the indication of the noise associated with the second received signal surpasses a threshold, the circuitry is configured to apply the first signal to the one or more electrodes for the first time period and second time period.

7. The circuitry of claim 1, wherein the first and second frequencies are selected such that there is reduced crosstalk between the first signal and the second signal.

8. The circuitry of claim 1, wherein the first signal generating module is configured to generate a modified first signal, the modified first signal being identical to the first signal but phase-shifted, and wherein determining whether a touch or object has been detected at the sensing surface is based on the result of applying the first signal to the first received signal and the first modified signal to the first received signal.

9. The circuitry of claim 8, wherein an indication of the noise associated with the first received signal is obtained by applying the first signal to the second received signal and the first modified signal to the second received signal.

10. The circuitry of claim 1, wherein the second signal generating module is configured to generate a modified second signal, the modified second signal being identical to the second signal but phase-shifted, and wherein determining whether a touch or object has been detected at the sensing surface is based on the result of applying the second signal to the second received signal and the second modified signal to the second received signal.

11. The circuitry of claim 10, wherein an indication of the noise associated with the second received signal is obtained by applying the second signal to the first received signal and the second modified signal to the first received signal.

12. The circuitry of claim 8, wherein the circuitry further comprises:
a first multiplier module configured to receive the first signal and the first received signal and multiply the two signals together;
a second multiplier module configured to receive the first modified signal and the first received signal and multiply the two signals together;
a third multiplier module configured to receive the second signal and the first received signal and multiply the two signals together;
a fourth multiplier module configured to receive the modified second signal and the first received signal and multiply the two signals together;
a received signal magnitude calculating module configured to receive the output from the first multiplier module and the second multiplier module and determine a magnitude of the first received signal on the basis of the output from the first and second multiplier modules; and
a received signal noise calculating module configured to receive the output from the third multiplier module and the fourth multiplier module and determine an indication of noise associated with the first received signal on the basis of the output from the third and fourth multiplier modules.

13. The circuitry of claim 12, wherein the circuitry further comprises:
a first accumulator module arranged so as to receive the output from the first multiplier module and provide an accumulated output from the first multiplier module to the received signal magnitude calculating module as the output from the first multiplier module;
a second accumulator module arranged so as to receive the output from the second multiplier module and provide an accumulated output from the second multiplier module to the received signal magnitude calculating module as the output from the second multiplier module;
a third accumulator module arranged so as to receive the output from the third multiplier module and provide an accumulated output from the third multiplier module to the received signal noise calculating module as the output from the third multiplier module; and
a fourth accumulator module arranged so as to receive the output from the fourth multiplier module and provide an accumulated output from the fourth multiplier module to the received signal noise calculating module as the output from the fourth multiplier module.

14. The circuitry of claim 12, wherein, during the second time period, the circuitry is configured such that the first multiplier module is configured to receive the second signal and the second received signal and multiply the two signals together, the second multiplier module is configured to receive the second modified signal and the second received signal and multiply the two signals together, the third multiplier module is configured to receive the first signal and the second received signal and multiply the two signals together, and the fourth multiplier module is configured to receive the modified first signal and the second received signal and multiply the two signals together, and
wherein the received signal magnitude calculating module is configured to receive the output from the first multiplier module and the second multiplier module and determine a magnitude of the second received signal on the basis of the output from the first and second multiplier modules; and
the received signal noise calculating module is configured to receive the output from the third multiplier module and the fourth multiplier module and determine an indication of noise associated with the second received signal on the basis of the output from the third and fourth multiplier modules.

15. The circuitry of claim 1, wherein the circuitry comprises at least one analogue-to-digital converter, ADC, and at least one digital-to-analogue converter, DAC, wherein the DAC is configured to receive a digital signal and convert the digital signal to an analogue signal and apply the analogue signal to the electrode array, and wherein the ADC is configured to receive an analogue signal from the electrode array and convert the analogue signal to a digital signal.

16. A touch-sensitive apparatus comprising:
the circuitry according to claim 1; and
an electrode array coupled to the circuitry.

17. A method for determining the presence of a touch or object at a touch-sensitive apparatus, the method comprising:
providing a first signal representing a sinusoidal wave having a first frequency;
providing a second signal representing a sinusoidal wave having a second frequency, the second frequency being different to the first frequency;
applying the first signal to one or more electrodes of an electrode array for a first time period and obtain a first received signal from the electrode array while the first signal is applied to the electrode array for the first time period;
applying the second signal to one or more electrodes of an electrode array for a second time period and obtain a second received signal from the electrode array while the second signal is applied to the electrode array for the second time period; and
determining whether a touch or object has been detected at a sensing surface corresponding to the electrode array based on the result of applying the first signal to the first received signal and/or applying the second signal to the second received signal, wherein
determining whether a touch or object has been detected at the sensing surface is further based on an indication of the noise associated with the first received signal and/or second received signal, wherein an indication of the noise associated with the first received signal is obtained by applying the first signal to the second received signal and wherein an indication of the noise associated with the second received signal is obtained by applying the second signal to the first received signal.
